(19) United States
(12) Patent Application Publication
(10) Pub. No.: US 2023/0349940 A1
(43) Pub. Date: Nov. 2, 2023

(54) PRESSURE-BASED LIQUID LEVEL DETECTION

(71) Applicant: Agilent Technologies, Inc.

(72) Inventors: Brian Sheldon, Katonah, NY (US); Michal Johannsen, Brøndby (DK); Andy Wu, Millbrae, CA (US)

(21) Appl. No.: 18/014,939

(22) PCT Filed: Aug. 9, 2021
(86) PCT No.: PCT/US2021/045240

§ 371 Date: Jan. 6, 2023

Related U.S. Application Data
(60) Provisional application No. 63/063,742, filed on Aug. 10, 2020.

(51) Int. Cl. G01N 35/10; G01F 23/18

(52) U.S. Cl. CPC G01N 35/1011; G01F 23/185; G01N 2035/1025; G01F 22/02

(57) ABSTRACT

Novel tools and techniques are provided for implementing liquid level detection, particularly, for implementing pressure-based liquid level detection, and, more particularly, for implementing pressure-based liquid level detection that takes into account presence of foam, wet septum seals on a container, and/or pressure changes caused by a partially sealed septum of a container.

### CROSS-REFERENCE TO RELATED APPLICATIONS

This application claims priority to and benefit of U.S. Provisional Patent Application No. 63/063,742, filed on Aug. 10, 2020, the contents of which are incorporated herein by reference in their entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing liquid level detection, particularly, in some embodiments, to methods, systems, and apparatuses for implementing pressure-based liquid level detection, and, more particularly, in some embodiments, to methods, systems, and apparatuses for implementing pressure-based liquid level detection that takes into account presence of foam, wet septum seals on a container, and/or pressure changes caused by a partially sealed septum of a container.

### BACKGROUND

Automated pipetting is a part of instrumentation used in a wide array of industries. It is advantageous if automated pipetting instruments can successfully aspirate from liquid samples with unknown starting volumes. This is commonly achieved by detecting the top of the liquid sample (also known as liquid level detection (“LLD”)). Using capacitance or conductance sensing are common LLD methods for finding the top of a liquid sample. These methods, however, do not work for non-conductive liquids. And, they cannot easily distinguish between the actual liquid and bubbles or foam on top of the liquid.

With other techniques, it is difficult to distinguish between bubbles or foam and the actual liquid. Also, containers that are sealed from the ambient atmosphere can cause measurement problems for pressure measurement techniques.

If automated pipetting instruments do not accurately find the level of liquid in a sample, they may not successfully aspirate that sample, which would compromise the application being performed. Instruments using capacitive or conductive sensing for LLD are known to have problems with non-conductive liquids or foamy liquids, as discussed above. Thus, these instruments may require extra user intervention to assess liquid volume, or might not accept certain liquids at all, or might need to compensate in other ways that can affect accuracy of liquid handling. Other approaches do not have limitations regarding non-conductive fluids, but can still have problems distinguishing foam or bubbles from liquid as well as detecting liquids in septa-sealed containers, as discussed above. These instruments might have limitations regarding the handling of samples before being loaded, might use algorithms that take longer to verify correct sensing, and might have restrictions on types of sample containers.

Hence, there is a need for more robust and scalable solutions for implementing liquid level detection, particularly, in some embodiments, to methods, systems, and apparatuses for implementing pressure-based liquid level detection, and, more particularly, in some embodiments, to methods, systems, and apparatuses for implementing pressure-based liquid level detection that takes into account presence of foam, wet septum seals on a container, and/or pressure changes caused by a partially sealed septum of a container.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing pressure-based liquid level detection, in accordance with various embodiments.

FIGS. 2A-2E are schematic diagrams illustrating a system for implementing pressure-based liquid level detection that takes into account presence of foam, wet septum seals on a container, and/or pressure changes caused by a pipette tip having passed through a partially sealed septum of a container, in accordance with various embodiments.

FIGS. 3A-3D are graphical diagrams illustrating non-limiting examples of pressure measurements over time corresponding to pressure-based liquid level detection and container conditions as depicted in FIGS. 2A-2D, in accordance with various embodiments.

FIG. 4 is a graphical diagram illustrating a non-limiting example of pressure measurements over time corresponding to pressure-based liquid level detection and container conditions using different motor configurations for a plunger motor and a Z-axis motor, in accordance with various embodiments.

FIGS. 5A-5C are flow diagrams illustrating a method for implementing pressure-based liquid level detection, in accordance with various embodiments.

FIGS. 6A-6D are flow diagrams illustrating another method for implementing pressure-based liquid level detection, in accordance with various embodiments.

FIG. 7 is a block diagram illustrating an exemplary computer or system hardware architecture, in accordance with various embodiments.

FIG. 8 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing liquid level detection, particularly, methods, systems, and apparatuses for implementing pressure-based liquid level detection, and, more particularly, methods, systems, and apparatuses for implementing pressure-based liquid level detection that takes into account presence of foam, wet septum seals on a container, and/or pressure changes caused by a partially sealed septum of a container.

In various embodiments, an apparatus might cause an automated pipettor to lower a pipette tip that is attached (whether removably or permanently attached) to a syringe of the automated pipettor into a container while simultaneously causing a plunger of the syringe to push air out of the pipette tip. The apparatus might receive air pressure measurements (whether continuously, periodically, randomly, or in response to commands for pressure measurements, or the like) from a pressure sensor that monitors air pressure within the syringe, as the automated pipettor is caused to lower the pipette tip into the container. The apparatus might analyze the received air pressure measurements to determine whether the pipette tip has made contact with a liquid in the container, in some cases, by identifying, from the air pressure measurements, a series of pressure spikes that exhibits a repetition pattern indicative of the pipette tip making contact with the liquid in the container. In some embodiments, the series of pressure spikes that exhibit a repetition pattern might comprise a plurality of (for example, at least four) consecutive pressure peaks (in some cases, at least five consecutive pressure peaks) having at least one of a regular period or a regular frequency. In some cases, the repetition pattern might comprise the plurality of consecutive pressure peaks having periods between adjacent pressure peaks that are substantially identical to each other or that are identical to each other to within a first predetermined threshold error value. In response to identifying such a series of pressure spikes, the apparatus might cause the automated pipettor to perform one or more tasks.

Merely by way of example, in some cases, performing the one or more tasks might comprise, based on a determination that the container contains an amount of liquid greater than a predetermined amount of liquid, aspirating the predetermined amount of liquid from the container and transferring the aspirated liquid to a receptacle (which might include, but is not limited to, one of a microscope slide or another container, or the like). Alternatively, or additionally, performing the one or more tasks might comprise, based on a determination that the container contains an amount of liquid less than the predetermined amount of liquid, performing one of: aspirating a remaining amount of liquid from the container, moving the pipette tip to a second container containing the same liquid, aspirating an amount of liquid from the second container so that the total amount of liquid in the pipette tip equals the predetermined amount of liquid, and transferring the aspirated liquid to the receptacle; moving the pipette tip to the second container containing the same liquid, aspirating the predetermined amount of liquid from the second container, and transferring the aspirated liquid to the receptacle; or sending or displaying a notification to a user to replace the container with another container having an amount of the same liquid that is greater than the predetermined amount of liquid. Alternatively, or additionally, performing the one or more tasks might comprise, based on a determination as to how many more aspirations of liquid can be obtained from the container based on the determined liquid level, sending or displaying a notification to the user indicating a determined number of remaining aspirations of liquid that can be obtained from the container. Alternatively, or additionally, performing the one or more tasks might comprise, based on a determination as to remaining volume of liquid that is in the container based on the determined liquid level, sending or displaying a notification to the user indicating the determined remaining volume of liquid that is in the container.

In some embodiments, the apparatus might track at least one of a distance that the pipette tip or the pipettor has moved or a position of the pipette tip or the pipettor relative to a reference position, and/or the like. According to some embodiments, the automated pipettor might be configured to aspirate at least a portion of the liquid from the container when two or more pressure spikes among the series of pressure spikes each has a slope value that is greater than a predetermined threshold slope value, wherein the two or more pressure spikes exhibit the repetition pattern indicative of the pipette tip making contact with the liquid in the container. Alternatively, or additionally, the automated pipettor might be configured to aspirate the at least a portion of the liquid from the container both when the series of pressure spikes exhibits the repetition pattern indicative of the pipette tip making contact with the liquid in the container and when the pipette tip is determined to be located within the container below a known position of a septum seal of the container. In some cases, the pipette tip might be determined to be located within the container below a known position of a septum seal of the container based on at least one of a distance that the pipette tip or the pipettor has moved or a position of the pipette tip or the pipettor relative to a reference position. Alternatively, or additionally, the automated pipettor might be configured to aspirate the at least a portion of the liquid based at least in part on at least one of previous determinations of liquid level of the liquid in the container, previous determinations of a volume of the liquid in the container, or previous aspirations of the liquid from the container, and/or the like.

According to some embodiments, the automated pipettor might be configured, using a first type of actuation, to push air through the pipette tip and might be configured, using a second type of actuation different from the first type of actuation, to move a syringe and the pipette tip that is affixed to the syringe downward toward the container. The apparatus might further be configured to distinguish pressure spikes corresponding to the first type of actuation from pressure spikes corresponding to the second type of actuation and to aspirate the liquid from the container when a series of pressure spikes caused by the first type of actuation exhibits the repetition pattern indicative of the pipette tip making contact with the liquid in the container. In some instances, the automated pipettor might further comprise a plunger motor and a Z-axis motor, wherein the plunger motor causes the first type of actuation, while the Z-axis motor causes the second type of actuation, wherein the first type of actuation and the second type of actuation are distinguishable from each other based on one of the following: the plunger motor comprises a servo motor, while the Z-axis motor comprises a stepper motor; the plunger motor comprises a stepper motor, while the Z-axis motor comprises a servo motor; the plunger motor and the Z-axis motor are both stepper motors, wherein a first pressure curve resultant from at least one of characteristics of the pipette tip or characteristics of the Z-axis motor that influence how the pipette tip moves is different from a second pressure curve resultant from at least one of characteristics of the plunger or characteristics of the plunger motor that influence how the plunger moves; or the plunger motor and the Z-axis motor are both servo motors, wherein a third pressure curve resultant from at least one of characteristics of the pipette tip or characteristics of the Z-axis motor that influence how the pipette tip moves is different from a fourth pressure curve resultant from at least one of characteristics of the plunger or characteristics of the plunger motor that influence how the plunger moves; wherein the characteristics of the pipette tip comprise an outer diameter of the pipette tip, wherein the characteristics of the Z-axis motor comprise at least one of type of motor, control of motor, or transmission between the motor and the pipette tip, and/or the like, wherein the characteristics of the plunger comprise a diameter of the plunger, wherein the characteristics of the plunger motor comprise at least one of type of motor, control of motor, or transmission between the motor and the plunger, and/or the like.

In some embodiments, the apparatus might determine a liquid level of the liquid in the container based on the determined repetition pattern exhibited by the pressure spikes as the pipette tip is moved within the container and based on an indication that the pipette tip has made contact with the liquid in the container.

In some embodiments, determining the liquid level of the liquid in the container might comprise determining a liquid level of the liquid in the container based at least in part on one or more of geometry of the container, height of the container, a distance between a reference point on the container and a reference point on the automated pipettor, height of the pipette tip relative to the reference point on the container, position of the pipette tip as the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, determining the liquid level of the liquid in the container might comprise determining a volume of the liquid in the container based at least in part on one or more of geometry of the container, height of the container, a distance between a reference point on the container and a reference point on the automated pipettor, height of the pipette tip relative to the reference point on the container, position of the pipette tip as the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, determining the liquid level of the liquid in the container might comprise determining a time at which the pipette tip made contact with the surface of the liquid in the container, the determined time corresponding to a start of the repetition pattern. In such cases, causing the automated pipettor to perform one or more tasks might comprise causing the automated pipettor to perform one or more tasks based on the determined time at which the pipette tip made contact with the surface of the liquid in the container.

According to some embodiments, the automated pipettor, for example by using a computing system, might analyze the received air pressure measurements to determine whether the pipette tip has made contact with foam that has accumulated above the surface of the liquid in the container, in some cases, by identifying, from the air pressure measurements, pressure measurements or a series of pressure spikes that is indicative of the pipette tip making contact with foam that has accumulated above the surface of the liquid in the container, said pressure measurements or series of pressure spikes comprising pressure peaks having periods between adjacent pressure peaks that are different from each other. In response to identifying said pressure measurements or series of pressure spikes, the automated pipettor, for example by using the computing system, might dismiss said pressure measurements or series of pressure spikes in determining the liquid level of the liquid in the container. In some embodiments, the automated pipettor might be configured to prevent the pipette from aspirating any liquid when a series of pressure spikes exhibits a lack of a regular repetition pattern, indicative of the pipette tip making contact with foam in the container.

Alternatively, or additionally, the automated pipettor, for example by using the computing system, might analyze the received air pressure measurements to determine whether the pipette tip has passed through a partially sealed septum of the container but not yet contacted liquid (i.e., has moved into an air-filled region between a wet septum seal and the surface of the liquid in the container), in some cases, by identifying, from the air pressure measurements, pressure measurements or a series of pressure spikes, each pressure spike in the series of pressure spikes having a slope value that is less than a predetermined threshold slope value, indicative of the pipette tip having passed through a partially sealed septum of the container but not yet contacted liquid, said pressure profile comprising consecutive pressure peaks having periods between adjacent pressure peaks that are substantially identical to each other or that are identical to each other to within a predetermined threshold error value. In response to identifying said pressure measurements or series of pressure spikes, the automated pipettor, for example by using the computing system, might dismiss said pressure measurements or series of pressure spikes in determining the liquid level of the liquid in the container. According to some embodiments, the automated pipettor might be configured to prevent the pipette from aspirating any liquid when each pressure spike in a series of pressure spikes has a slope value that is less than a predetermined threshold slope value, indicative of the pipette tip having passed through a partially sealed septum of the container but not yet contacted liquid.

According to some embodiments, the automated pipettor, for example by using the computing system, might be configured to move the pipette tip from a position above the container to a second position along an X-Y plane that is parallel to a workspace surface on which the base is disposed, by sending command instructions to an X-Y stage to cause the syringe to move to the second position along the X-Y plane. In this manner, the automated pipettor may align the pipette tip directly above a container or may move the pipette tip from above one container to above another container, prior to lowering the pipette tip into the selected container.

In accordance with the various embodiments described herein, the pressure-based liquid level detection techniques and systems herein allow for accurate detection of the actual liquid level for any type of liquid, in a wide variety of containers, and regardless of presence of bubbles or foam, or whether the containers are partially or fully sealed (for example, whether there is liquid on septum seals or top seals of the containers, or the like). This results in more versatile automation instrumentation. Users also have less restrictions in terms of the samples that they can use, how they store those samples, and how they prepare or handle those samples prior to loading onto the instrument (for example, they don't have to worry about inadvertently shaking the containers, thereby causing foam to form above or on the surface of the liquid in the containers and/or causing liquid to accumulate around the septum seal of the containers, etc.).

These and other aspects of the pressure-based liquid level detection system and functionality are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, liquid level detection technology, and/or the like. In other aspects, certain embodiments, can improve the functioning of user equipment or systems themselves (for example, liquid level detection systems, etc.), for example, by causing an automated pipettor to lower a pipette tip that is attached to a syringe of the automated pipettor into a container while simultaneously pushing air out of the pipette tip; receiving air pressure measurements from a pressure sensor that monitors air pressure within the syringe, as the automated pipettor is caused to lower the pipette tip into the container; analyzing the received air pressure measurements to determine whether the pipette tip has made contact with a liquid in the container, by identifying, from the air pressure measurements, a series of pressure spikes that exhibits a repetition pattern indicative of the pipette tip making contact with the liquid in the container; in response to identifying such a series of pressure spikes, causing the automated pipettor to perform one or more tasks; and/or the like.

In particular, to the extent any abstract concepts are present in the various embodiments, those concepts can be implemented as described herein by devices, software, systems, and methods that involve specific novel functionality (for example, steps or operations), such as, analyzing the received air pressure measurements to determine whether the pipette tip has made contact with a liquid in the container, by identifying, from the air pressure measurements, a series of pressure spikes that exhibits a repetition pattern indicative of the pipette tip making contact with the liquid in the container; and in response to identifying such a series of pressure spikes, causing the automated pipettor to perform one or more tasks; and/or the like, to name a few examples, that extend beyond mere conventional computer processing operations. These functionalities can produce tangible results outside of the implementing computer system, including, merely by way of example, optimized and improved pressure-based liquid level detection that takes into account presence of foam, wet septum seals on a container, and/or pressure changes caused by a partially sealed septum of a container, and/or the like, at least some of which may be observed or measured by users.

In an aspect, an apparatus might comprise an automated pipettor having a pipette tip affixed thereto; and a pressure sensor in fluid communication with the pipette tip. The apparatus might be configured to aspirate at least a portion of the liquid from a container having a liquid contained therein when a series of pressure spikes exhibits a repetition pattern indicative of the pipette tip making contact with the liquid in the container.

In some embodiments, the repetition pattern indicative of the pipette tip making contact with the liquid in the container might comprise at least one of a regular period or a regular frequency among two or more pressure spikes in the series of pressure spikes, and/or the like. According to some embodiments, the apparatus might be further configured to track at least one of a distance that the pipette tip or the pipettor has moved or a position of the pipette tip or the pipettor relative to a reference position, and/or the like.

According to some embodiments, the apparatus might be further configured to aspirate the at least a portion of the liquid from the container when two or more pressure spikes among the series of pressure spikes each has a slope value that is greater than a predetermined threshold slope value, wherein the two or more pressure spikes exhibit the repetition pattern indicative of the pipette tip making contact with the liquid in the container.

Alternatively, or additionally, the apparatus might be further configured to aspirate the at least a portion of the liquid from the container both when the series of pressure spikes exhibits the repetition pattern indicative of the pipette tip making contact with the liquid in the container and when the pipette tip is determined to be located within the container below a known position of a septum seal of the container. In some cases, the pipette tip might be determined to be located within the container below a known position of a septum seal of the container based on at least one of a distance that the pipette tip or the pipettor has moved or a position of the pipette tip or the pipettor relative to a reference position.

Alternatively, or additionally, the apparatus might be further configured to aspirate the at least a portion of the liquid based at least in part on at least one of previous determinations of liquid level of the liquid in the container, previous determinations of a volume of the liquid in the container, or previous aspirations of the liquid from the container, and/or the like.

In some embodiments, the automated pipettor might be configured, using a first type of actuation, to push air through the pipette tip and configured, using a second type of actuation different from the first type of actuation, to move a syringe and the pipette tip that is affixed to the syringe downward toward the container, wherein the apparatus might be further configured to distinguish pressure spikes corresponding to the first type of actuation from pressure spikes corresponding to the second type of actuation and to aspirate the liquid from the container when a series of pressure spikes caused by the first type of actuation exhibits the repetition pattern indicative of the pipette tip making contact with the liquid in the container. In some instances, the automated pipettor might further comprise a plunger motor and a Z-axis motor, wherein the plunger motor might cause the first type of actuation, while the Z-axis motor might cause the second type of actuation, wherein the first type of actuation and the second type of actuation are distinguishable from each other based on one of the following: the plunger motor comprises a servo motor, while the Z-axis motor comprises a stepper motor; the plunger motor comprises a stepper motor, while the Z-axis motor comprises a servo motor; the plunger motor and the Z-axis motor are both stepper motors, wherein a first pressure curve resultant from at least one of characteristics of the pipette tip or characteristics of the Z-axis motor that influence how the pipette tip moves is different from a second pressure curve resultant from at least one of characteristics of the plunger or characteristics of the plunger motor that influence how the plunger moves; or the plunger motor and the Z-axis motor are both servo motors, wherein a third pressure curve resultant from at least one of characteristics of the pipette tip or characteristics of the Z-axis motor that influence how the pipette tip moves is different from a fourth pressure curve resultant from at least one of characteristics of the plunger or characteristics of the plunger motor that influence how the plunger moves; wherein the characteristics of the pipette tip comprise an outer diameter of the pipette tip, wherein the characteristics of the Z-axis motor comprise at least one of type of motor, control of motor, or transmission between the motor and the pipette tip, and/or the like, wherein the characteristics of the plunger comprise a diameter of the plunger, wherein the characteristics of the plunger motor comprise at least one of type of motor, control of motor, or transmission between the motor and the plunger, and/or the like; and/or the like.

According to some embodiments, the repetition pattern might comprise at least four pressure spikes having periods between adjacent pressure spikes that are identical to each other to within a first predetermined threshold error value. In some cases, the apparatus might be further configured to: determine a liquid level of the liquid in the container based on the determined repetition pattern exhibited by the pressure spikes as the pipette tip is moved within the container and based on an indication that the pipette tip has made contact with the liquid in the container.

In some embodiments, determining the liquid level of the liquid in the container might comprise determining a liquid level of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to a leading pressure valley preceding the repetition pattern relative to a known position of the top seal of the container, and/or the like.

Alternatively, or additionally, determining the liquid level of the liquid in the container might comprise determining a volume of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to a leading pressure valley preceding the repetition pattern relative to a known position of the top seal of the container; and/or the like.

Alternatively, or additionally, determining the liquid level of the liquid in the container might comprise determining a time at which the pipette tip made contact with the surface of the liquid in the container, the determined time corresponding to a start of the repetition pattern.

According to some embodiments, the apparatus might comprise at least one of a processor disposed in the automated pipettor, a computing system communicatively coupled to the automated pipettor and disposed in the work environment, a remote computing system disposed external to the work environment and accessible over a network, or a cloud computing system, and/or the like.

In some embodiments, the apparatus might be further configured to prevent the automated pipettor from aspirating any liquid when a series of pressure spikes exhibits a lack of a regular repetition pattern, indicative of the pipette tip making contact with foam in the container. Alternatively, or additionally, the apparatus might be further configured to prevent the automated pipettor from aspirating any liquid when each pressure spike in a series of pressure spikes has a slope value that is less than a predetermined threshold slope value, indicative of the pipette tip having passed through a partially sealed septum of the container but not yet contacted liquid.

In another aspect, a method might comprise lowering an automated pipettor having a pipette tip in liquid communication therewith into a container while dispensing air from the pipette tip and measuring air pressure within the pipette tip; and aspirating, using the automated pipettor, at least a portion of a liquid in the container when a series of pressure spikes exhibits a repetition pattern indicative of the pipette tip making contact with liquid in the container.

In some embodiments, the repetition pattern indicative of the pipette tip making contact with the liquid in the container might comprise at least one of a regular period or a regular frequency among two or more pressure spikes in the series of pressure spikes. Alternatively, or additionally, the repetition pattern might comprise at least four pressure spikes having periods between adjacent pressure spikes that are identical to each other to within a first predetermined threshold error value.

According to some embodiments, the method might further comprise tracking at least one of a distance that the pipette tip or the pipettor has moved or a position of the pipette tip or the pipettor relative to a reference position, and/or the like.

In some embodiments, the method might further comprise aspirating the at least a portion of the liquid from the container when two or more pressure spikes among the series of pressure spikes each has a slope value that is greater than a predetermined threshold slope value, wherein the two or more pressure spikes exhibit the repetition pattern indicative of the pipette tip making contact with the liquid in the container. Alternatively, or additionally, the method might further comprise aspirating the at least a portion of the liquid from the container both when the series of pressure spikes exhibits the repetition pattern indicative of the pipette tip making contact with the liquid in the container and when the pipette tip is determined to be located within the container below a known position of a septum seal of the container. In some cases, the pipette tip might be determined to be located within the container below a known position of a septum seal of the container based on at least one of a distance that the pipette tip or the pipettor has moved or a position of the pipette tip or the pipettor relative to a reference position. Alternatively, or additionally, the method might further comprise aspirating the at least a portion of the liquid based at least in part on at least one of previous determinations of liquid level of the liquid in the container, previous determinations of a volume of the liquid in the container, or previous aspirations of the liquid from the container, and/or the like.

According to some embodiments, the method might further comprise preventing the automated pipettor from aspirating any liquid when a series of pressure spikes exhibits a lack of a regular repetition pattern, indicative of the pipette tip making contact with foam in the container. Alternatively, or additionally, the method might further comprise preventing the automated pipettor from aspirating any liquid when each pressure spike in a series of pressure spikes has a slope value that is less than a predetermined threshold slope value, indicative of the pipette tip having passed through a partially sealed septum of the container but not yet contacted liquid.

In yet another aspect, a method might comprise causing an automated pipettor to lower a pipette tip that is attached to a syringe of the automated pipettor into a container while simultaneously pushing air out of the pipette tip; receiving air pressure measurements from a pressure sensor that monitors air pressure within the syringe, as the automated pipettor is caused to lower the pipette tip into the container; analyzing the received air pressure measurements to determine whether the pipette tip has made contact with a liquid in the container, by identifying, from the air pressure measurements, a series of pressure spikes that exhibits a repetition pattern indicative of the pipette tip making contact with the liquid in the container; and in response to identifying such a series of pressure spikes, causing the automated pipettor to perform one or more tasks.

In some embodiments, the repetition pattern indicative of the pipette tip making contact with the liquid in the container might comprise at least one of a regular period or a regular frequency among two or more pressure spikes in the series of pressure spikes. In some cases, the repetition pattern might comprise at least four consecutive pressure peaks having periods between adjacent pressure peaks that are identical to each other to within a first predetermined threshold error value. In some instances, the series of pressure spikes might comprise two or more pressure spikes each having a slope value that is greater than a predetermined threshold slope value, wherein the two or more pressure spikes exhibit the repetition pattern indicative of the pipette tip making contact with the liquid in the container.

According to some embodiments, the method might further comprise determining a liquid level of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, the method might further comprise determining a volume of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, the method might further comprise determining a time at which the pipette tip made contact with the liquid in the container, the determined time corresponding to a start of the repetition pattern; wherein causing the automated pipettor to perform one or more tasks might comprise causing the automated pipettor to perform one or more tasks based on the determined time at which the pipette tip made contact with the liquid in the container.

In some embodiments, the method might further comprise analyzing the received air pressure measurements to determine whether the pipette tip has made contact with foam in the container, by identifying, from the air pressure measurements, a series of pressure spikes that exhibits a lack of a regular repetition pattern, indicative of the pipette tip making contact with foam in the container; and in response to identifying such a series of pressure spikes, preventing the automated pipettor from aspirating any liquid.

Alternatively, or additionally, the method might further comprise analyzing the received air pressure measurements to determine whether the pipette tip has passed through a partially sealed septum of the container but not yet contacted liquid, by identifying, from the air pressure measurements, a series of pressure spikes, each pressure spike in the series of pressure spikes having a slope value that is less than a predetermined threshold slope value, indicative of the pipette tip having passed through a partially sealed septum of the container but not yet contacted liquid; and in response to identifying such a series of pressure spikes, preventing the automated pipettor from aspirating any liquid.

According to some embodiments, performing the one or more tasks comprises at least one of: based on a determination that the container contains an amount of liquid greater than a predetermined amount of liquid, aspirating the predetermined amount of liquid from the container and transferring the aspirated liquid to a receptacle; based on a determination that the container contains an amount of liquid less than the predetermined amount of liquid, performing one of: aspirating a remaining amount of liquid from the container, moving the pipette tip to a second container containing the same liquid, aspirating an amount of liquid from the second container so that the total amount of liquid in the pipette tip equals the predetermined amount of liquid, and transferring the aspirated liquid to the receptacle; moving the pipette tip to the second container containing the same liquid, aspirating the predetermined amount of liquid from the second container, and transferring the aspirated liquid to the receptacle; or sending or displaying a notification to a user to replace the container with another container having an amount of the same liquid that is greater than the predetermined amount of liquid; based on a determination as to how many more aspirations of liquid can be obtained from the container based on the determined liquid level, sending or displaying a notification to the user indicating a determined number of remaining aspirations of liquid that can be obtained from the container; or based on a determination as to remaining volume of liquid that is in the container based on the determined liquid level, sending or displaying a notification to the user indicating the determined remaining volume of liquid that is in the container. In some cases, the receptacle might comprise one of a microscope slide or a third container, or the like.

In still another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: cause an automated pipettor to lower a pipette tip that is attached to a syringe of the automated pipettor into a container while simultaneously pushing air out of the pipette tip; receive air pressure measurements from a pressure sensor that monitors air pressure within the syringe, as the automated pipettor is caused to lower the pipette tip into the container; analyze the received air pressure measurements to determine whether the pipette tip has made contact with a liquid in the container, by identifying, from the air pressure measurements, a series of pressure spikes that exhibits a repetition pattern indicative of the pipette tip making contact with the liquid in the container; and in response to identifying such a series of pressure spikes, cause the automated pipettor to perform one or more tasks.

In some embodiments, the automated pipettor might be disposed within a work environment, wherein the apparatus might comprise at least one of a processor disposed in the automated pipettor, a computing system communicatively coupled to the automated pipettor and disposed in the work environment, a remote computing system disposed external to the work environment and accessible over a network, or a cloud computing system, and/or the like.

In yet another aspect, a system might comprise an automated pipettor and an apparatus. The automated pipettor might comprise a base; a syringe comprising a syringe body and a plunger; a first motor configured to cause the plunger to move upward or downward relative to the syringe body; a pressure sensor that monitors air pressure within the syringe; and a second motor configured to cause the syringe to move upward or downward relative to the base, wherein a container is disposed in a position that is stationary relative to the base of the automated pipettor.

The apparatus might be configured to: cause the automated pipettor to lower a pipette tip that is attached to the syringe of the automated pipettor into the container, by sending first command instructions to the second motor to cause the syringe to move downward relative to the container, while simultaneously causing the plunger of the syringe to continuously and slowly push air out of the pipette tip, by sending second command instructions to the first motor to cause the plunger to move downward relative to the syringe body; receive air pressure measurements from the pressure sensor, as the automated pipettor is caused to lower the pipette tip into the container; analyze the received air pressure measurements to determine whether the pipette tip has made contact with a liquid in the container, by identifying, from the air pressure measurements, a series of pressure spikes that exhibits a repetition pattern indicative of the pipette tip making contact with the liquid in the container; and in response to identifying such a series of pressure spikes, cause the automated pipettor to perform one or more tasks.

In some embodiments, the repetition pattern indicative of the pipette tip making contact with the liquid in the container might comprise at least one of a regular period or a regular frequency among two or more pressure spikes in the series of pressure spikes. In some cases, the series of pressure spikes might comprise two or more pressure spikes each having a slope value that is greater than a predetermined threshold slope value, wherein the two or more pressure spikes exhibit the repetition pattern indicative of the pipette tip making contact with the liquid in the container.

According to some embodiments, the automated pipettor might further comprise an X-Y stage that is configured to move the syringe along an X-Y plane that is parallel to a workspace surface on which the base is disposed, wherein the first set of instructions, when executed by the at least one first processor, might further cause the apparatus to: cause the automated pipettor to move the pipette tip from a position above the container to a second position along the X-Y plane, by sending third command instructions to the X-Y stage to cause the syringe to move to the second position along the X-Y plane.

In some embodiments, the automated pipettor might be disposed within a work environment, wherein the apparatus might comprise at least one of a processor disposed in the automated pipettor, a computing system communicatively coupled to the automated pipettor and disposed in the work environment, a remote computing system disposed external to the work environment and accessible over a network, or a cloud computing system, and/or the like.

According to some embodiments, the apparatus might be further configured to: analyze the received air pressure measurements to determine whether the pipette tip has made contact with foam in the container, by identifying, from the air pressure measurements, a series of pressure spikes that exhibits a lack of a regular repetition pattern, indicative of the pipette tip making contact with foam in the container; and in response to identifying such a series of pressure spikes, preventing the automated pipettor from aspirating any liquid.

Alternatively, or additionally, the apparatus might be further configured to: analyze the received air pressure measurements to determine whether the pipette tip has passed through a partially sealed septum of the container but not yet contacted liquid, by identifying, from the air pressure measurements, a series of pressure spikes, each pressure spike in the series of pressure spikes having a slope value that is less than a predetermined threshold slope value, indicative of the pipette tip having passed through a partially sealed septum of the container but not yet contacted liquid; and in response to identifying such a series of pressure spikes, preventing the automated pipettor from aspirating any liquid.

In some embodiments, performing the one or more tasks might comprise at least one of: based on a determination that the container contains an amount of liquid greater than a predetermined amount of liquid, aspirating the predetermined amount of liquid from the container and transferring the aspirated liquid to a receptacle; based on a determination that the container contains an amount of liquid less than the predetermined amount of liquid, performing one of: aspirating a remaining amount of liquid from the container, moving the pipette tip to a second container containing the same liquid, aspirating an amount of liquid from the second container so that the total amount of liquid in the pipette tip equals the predetermined amount of liquid, and transferring the aspirated liquid to the receptacle; moving the pipette tip to the second container containing the same liquid, aspirating the predetermined amount of liquid from the second container, and transferring the aspirated liquid to the receptacle; or sending or displaying a notification to a user to replace the container with another container having an amount of the same liquid that is greater than the predetermined amount of liquid; based on a determination as to how many more aspirations of liquid can be obtained from the container based on the determined liquid level, sending or displaying a notification to the user indicating a determined number of remaining aspirations of liquid that can be obtained from the container; or based on a determination as to remaining volume of liquid that is in the container based on the determined liquid level, sending or displaying a notification to the user indicating the determined remaining volume of liquid that is in the container.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

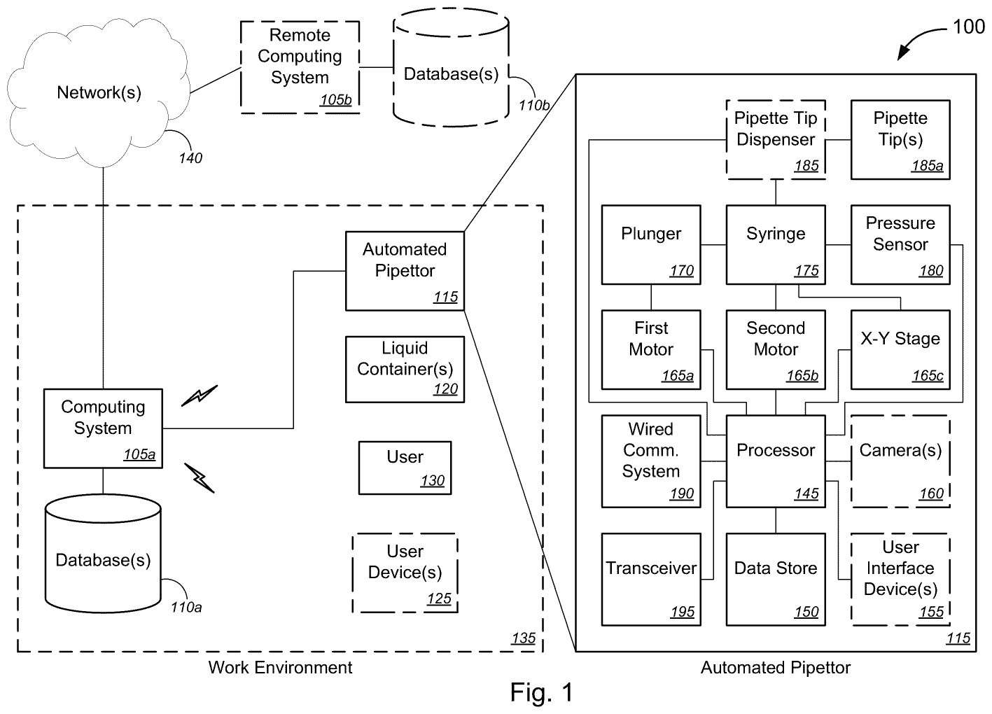

We now turn to the embodiments as illustrated by the drawings. FIGS. 1-8 illustrate some of the features of the method, system, and apparatus for implementing liquid level detection, particularly, to methods, systems, and apparatuses for implementing pressure-based liquid level detection, and, more particularly, to methods, systems, and apparatuses for implementing pressure-based liquid level detection that takes into account presence of foam, wet septum seals on a container, and/or pressure changes caused by a partially sealed septum of a container, as referred to above. The methods, systems, and apparatuses illustrated by FIGS. 1-8 refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

With reference to the figures, FIG. 1 is a schematic diagram illustrating a system 100 for implementing pressure-based liquid level detection, in accordance with various embodiments.

In the non-limiting embodiment of FIG. 1, system 100 might comprise computing system 105a and corresponding database(s) 110a. In some instances, the database(s) 110a might be local to the computing system 105a, in some cases, integrated within the computing system 105a. In other cases, the database 110a might be external, yet communicatively coupled, to the computing system 105a. System 100, according to some embodiments, might further comprise an automated pipette or pipettor 115 (hereinafter referred to as “automated pipettor” or the like), one or more containers 120, and one or more user devices 125 (optional) that are associated with (and/or used by) user 130. The computing system 105a, the database(s) 110a, the automated pipettor 115, the one or more containers 120, and the user devices 125 may be disposed, or located, within work environment 135, which might include, but is not limited to, a laboratory, a clinic, a medical facility, or a pharmaceutical facility, or the like.

System 100 might further comprise a remote computing system 105b (optional) and corresponding database(s) 110b (optional) that communicatively couple with computing system 105a, automated pipettor 115, and/or user device(s) 125 (either directly or indirectly) via network(s) 140. Merely by way of example, network(s) 140 might each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, network(s) 140 might each include an access network of an Internet service provider (“ISP”). In another embodiment, network(s) 140 might each include a core network of the ISP, and/or the Internet.

In some embodiments, computing system 105a might include, but is not limited to, one of a processor disposed in the automated pipettor 115 or a computing system communicatively coupled to the automated pipettor 115 and disposed in the work environment 135, and/or the like, while remote computing system 105b might include, without limitation, a remote computing system disposed external to the work environment 135 and accessible over network(s) 140 or a cloud computing system, and/or the like. In some instances, the user device(s) 125 might include, but is not limited to, one or more of a smart phone, a mobile phone, a tablet computer, a laptop computer, a desktop computer, or an augmented reality (“AR”) headset, or the like.

According to some embodiments, the automated pipettor 115 might include, but is not limited to, at least one of a processor 145, a database or data store 150, a user interface device(s) 155 (optional; including, without limitation, at least one of buttons, switches, toggles, keys, indicator lights, non-touch display screen(s), touchscreen display(s), and/or the like), one or more cameras 160 (optional), motorized components (including, without limitation, a first motor 165a, a second motor 165b, an X-Y stage 165c, and/or the like), a plunger 170, a syringe 175, a pressure sensor 180, a pipette tip dispenser or exchanger 185 (optional), one or more pipette tips 185a (which may include, without limitation, metal pipette tips, plastic pipette tips, glass pipette tips, or the like), a wired communications system 190, and/or a (wireless) transceiver 195, and/or the like. The first motor 165a (also referred to herein as “plunger motor” or the like) might be configured to cause the plunger 170 to move upward or downward relative to the body of the syringe 175, while the second motor 165b (also referred to herein as “Z-axis motor” or the like) might be configured to cause the syringe 175 to move upward or downward relative to a base of (or other fixed reference point on) the automated pipettor 135. Although some components of the automated pipettor 115 are denoted with respect to FIG. 1 as being optional while others are not, the various embodiments are not so limited, and any of the components 145-195 may be part of the automated pipettor 115 or may be optional. Further, although certain components 145-195 are denoted as being part of the automated pipettor 115, some of these components (for example, one or more of processor 145, data store 150, user interface device(s) 155, camera(s) 160, pressure sensor 180, pipette tip dispenser 185, pipette tip(s) 185a, wired communications system 190, and/or transceiver 195, or the like) may be external devices or systems that may work in conjunction with the automated pipettor 115, perhaps also in conjunction with computing system 105a or 105b and/or user device(s) 125, or the like.

In operation, computing system 105a, user device(s) 125, and/or remote computing system 105b (collectively, “computing system” or the like) might cause automated pipettor 115 to lower a pipette tip (for example, one of pipette tips 185a, or the like) that is attached (whether removably or permanently attached) to a syringe (for example, syringe 175, or the like) of the automated pipettor 115 into a container (for example, container 120 among the one or more containers 120, or the like) while simultaneously causing a plunger of the syringe (for example, plunger 170 of syringe 175, or the like) to push air out of the pipette tip (for example, pipette tip 185a, or the like). In some cases, for removably affixed pipette tips, one of the pipette tips 185a might be used to aspirate at least a portion of the liquid from one container among the containers 120, and then may be subsequently disposed of using the pipette tip dispenser or exchanger 185 or the like, with a new (and unused) pipette tip among the pipette tips 185a being affixed to the syringe 175 (in some cases, using the pipette tip dispenser or exchanger 185 or the like) in preparation for aspirating liquid from a different container 120. By using different pipette tips with different liquids or with different containers (regardless of whether the same liquid is in multiple containers that are used), cross-contamination may be limited or avoided, and, with the use of clean or new pipette tips, “clean” pressure measurements can be assured (assuming no liquid ever aspirates or enters the syringe 175, and rather remains only in the pipette tips 185a), thereby allowing for more accurate and precise pressure-based liquid level detection (as described in detail below). Some automated pipettors, however, are designed with fixed or permanent pipette tips, in which case, cleaning cycles (during which the pipette tip is cleaned using predetermined cleaning protocols or the like) may be implemented between aspirations to ensure “clean” pressure measurements for successive operations.

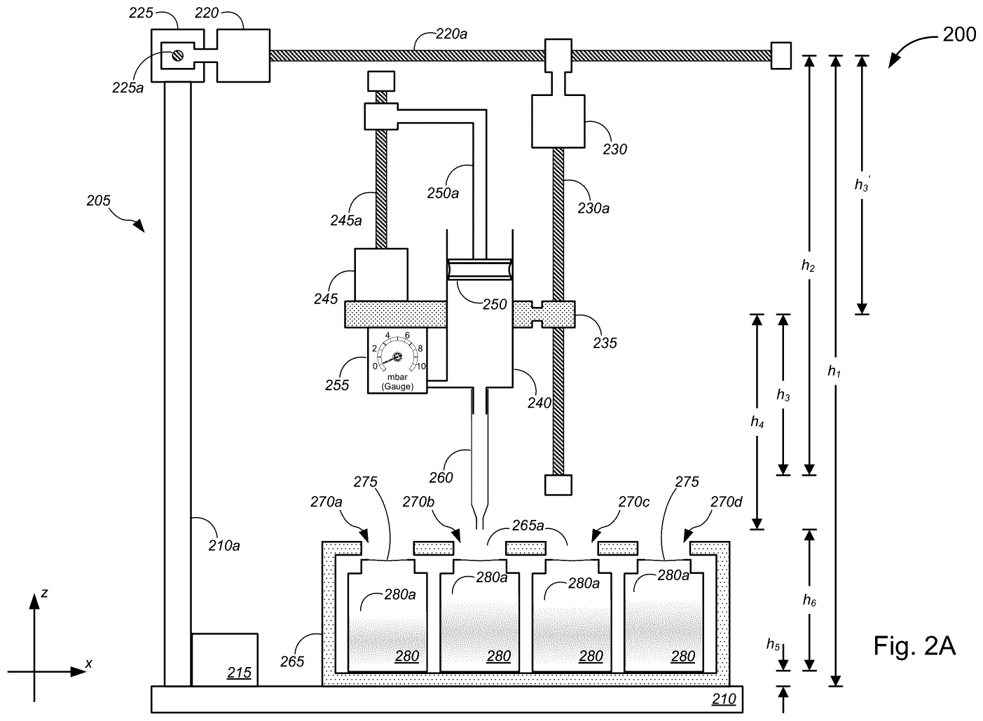

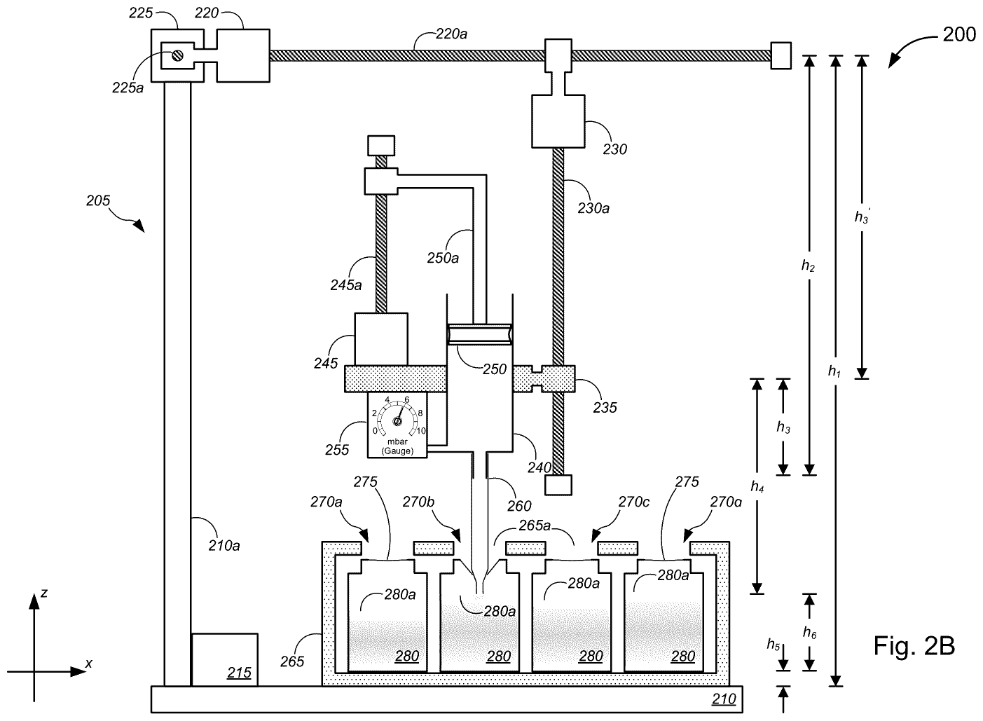

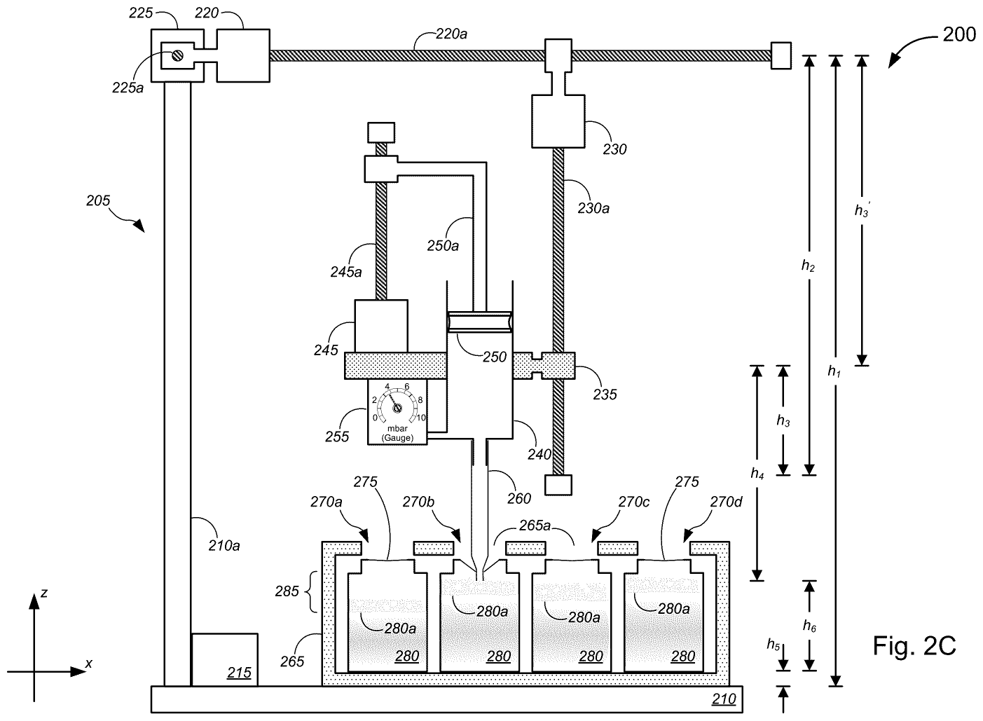

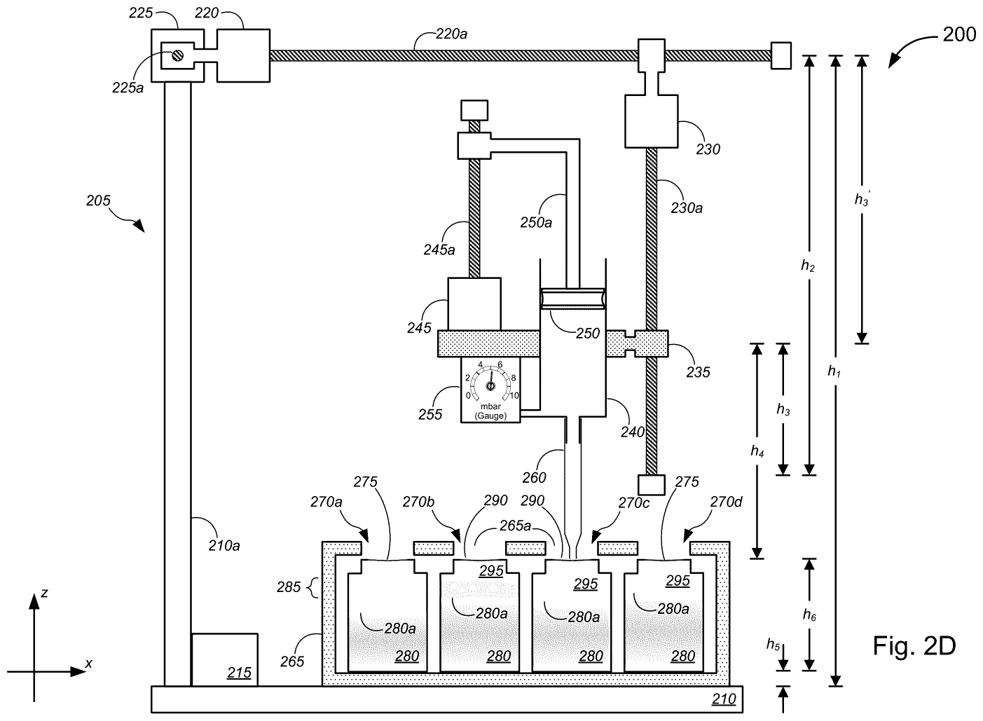

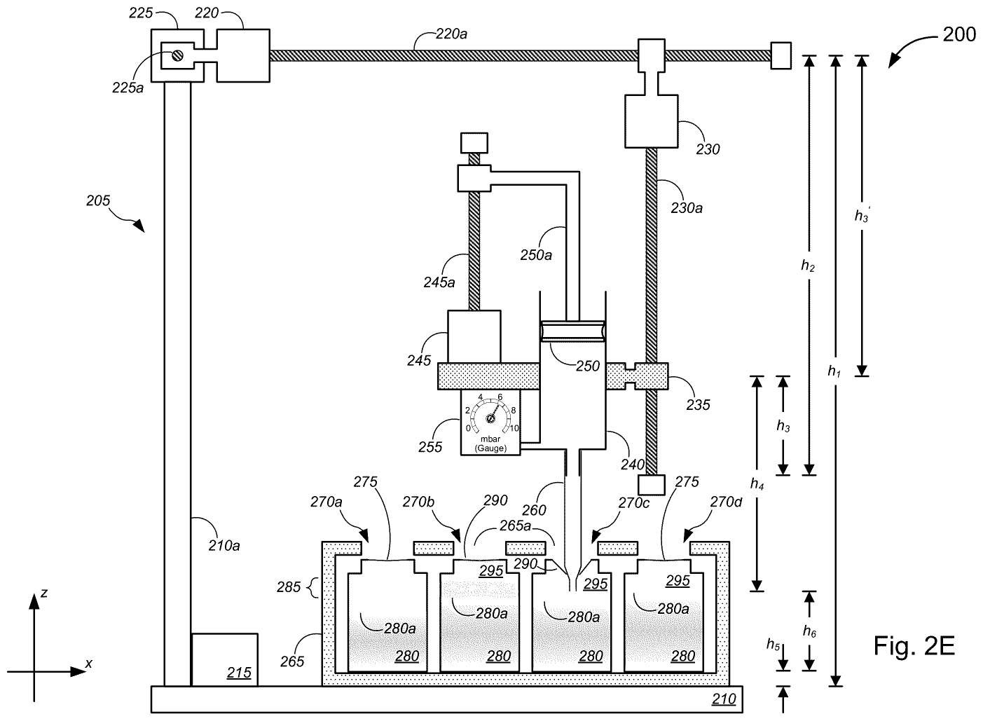

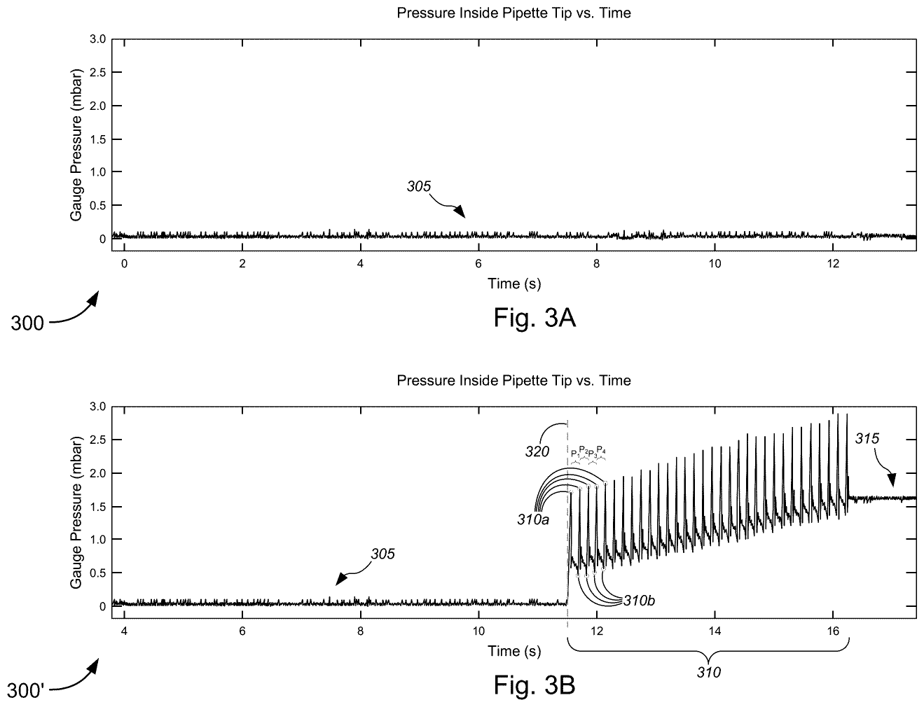

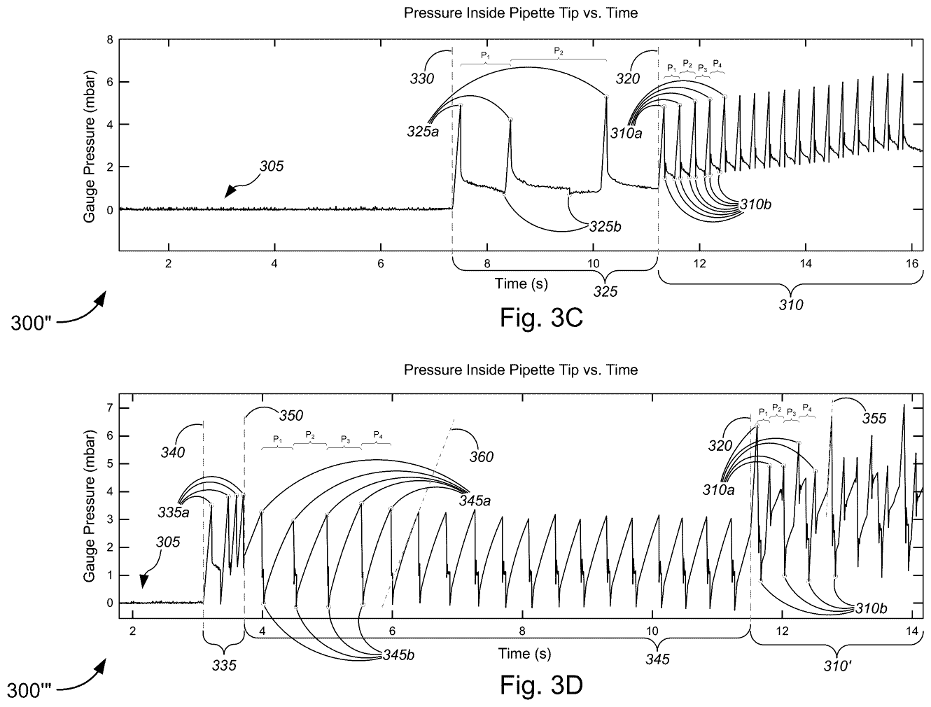

The automated pipettor 115, for example by using the computing system, might receive air pressure measurements (whether continuously, periodically, randomly, or in response to commands for pressure measurements, or the like) from a pressure sensor (for example, pressure sensor 180, or the like) that monitors air pressure within the syringe (for example, syringe 175, or the like), as the automated pipettor 115 is caused to lower the pipette tip (for example, pipette tip 185a, or the like) into the container (for example, container 120, or the like). The automated pipettor, for example by using the computing system, might analyze the received air pressure measurements to determine whether the pipette tip has made contact with a liquid in the container, in some cases, by identifying, from the air pressure measurements, pressure measurements or a series of pressure spikes that exhibits a repetition pattern indicative of the pipette tip making contact with the liquid in the container (such as depicted, for example, by pressure measurements or series of pressure spikes 310 in FIG. 3B, or the like, which corresponds to the pipette tip 260 making contact with the liquid 280 in container 270b as depicted in FIG. 2B, or the like). In some embodiments, the pressure measurements or series of pressure spikes that exhibit a repetition pattern might comprise a plurality of (for example, at least four) consecutive pressure peaks (in some cases, at least five consecutive pressure peaks) having at least one of a regular period or a regular frequency. In some cases, the repetition pattern might comprise the plurality of consecutive pressure peaks having periods between adjacent pressure peaks that are substantially identical to each other or that are identical to each other to within a first predetermined threshold error value (which might include, but is not limited to, one of about 10 ms, about 20 ms, about 30 ms, about 40 ms, about 50 ms, about 60 ms, about 70 ms, about 80 ms, about 90 ms, about 100 ms, about 125 ms, about 150 ms, about 175 ms, about 200 ms, about 225 ms, about 250 ms, about 275 ms, about 300 ms, about 325 ms, about 350 ms, about 375 ms, about 400 ms, about 425 ms, about 450 ms, about 475 ms, about 500 ms, or the like, or a threshold error value in a range between about 1 ms and about 500 ms). In response to identifying such a series of pressure spikes, the computing system might cause the automated pipettor 115 to perform one or more tasks.

Merely by way of example, in some cases, performing the one or more tasks might comprise, based on a determination that the container contains an amount of liquid greater than a predetermined amount of liquid, aspirating the predetermined amount of liquid from the container and transferring the aspirated liquid to a receptacle (which might include, but is not limited to, one of a microscope slide or another container, or the like). Alternatively, or additionally, performing the one or more tasks might comprise, based on a determination that the container contains an amount of liquid less than the predetermined amount of liquid, performing one of: aspirating a remaining amount of liquid from the container, moving the pipette tip to a second container containing the same liquid, aspirating an amount of liquid from the second container so that the total amount of liquid in the pipette tip equals the predetermined amount of liquid, and transferring the aspirated liquid to the receptacle; moving the pipette tip to the second container containing the same liquid, aspirating the predetermined amount of liquid from the second container, and transferring the aspirated liquid to the receptacle; or sending or displaying a notification to a user (for example, user 130, or the like, via user device(s) 125, or the like) to replace the container with another container having an amount of the same liquid that is greater than the predetermined amount of liquid. Alternatively, or additionally, performing the one or more tasks might comprise, based on a determination as to how many more aspirations of liquid can be obtained from the container based on the determined liquid level, sending or displaying a notification to the user (for example, user 130, or the like, via user device(s) 125, or the like) indicating a determined number of remaining aspirations of liquid that can be obtained from the container. Alternatively, or additionally, performing the one or more tasks might comprise, based on a determination as to remaining volume of liquid that is in the container based on the determined liquid level, sending or displaying a notification to the user (for example, user 130, or the like, via user device(s) 125, or the like) indicating the determined remaining volume of liquid that is in the container.

In some embodiments, the automated pipettor, for example by using the computing system, might track at least one of a distance that the pipette tip or the pipettor has moved or a position of the pipette tip or the pipettor relative to a reference position, and/or the like. According to some embodiments, the computing system might cause the automated pipettor 115 (and/or the automated pipettor 115 might be configured) to aspirate at least a portion of the liquid from the container when two or more pressure spikes among the series of pressure spikes each has a slope value that is greater than a predetermined threshold slope value, wherein the two or more pressure spikes exhibit the repetition pattern indicative of the pipette tip making contact with the liquid in the container. Alternatively, or additionally, the computing system might cause the automated pipettor 115 (and/or the automated pipettor 115 might be configured) to aspirate the at least a portion of the liquid from the container both when the series of pressure spikes exhibits the repetition pattern indicative of the pipette tip making contact with the liquid in the container and when the pipette tip is determined to be located within the container below a known position of a septum seal of the container. In some cases, the pipette tip might be determined to be located within the container below a known position of a septum seal of the container based on at least one of a distance that the pipette tip or the pipettor has moved or a position of the pipette tip or the pipettor relative to a reference position. Alternatively, or additionally, the computing system might cause the automated pipettor 115 (and/or the automated pipettor 115 might be configured) to aspirate the at least a portion of the liquid based at least in part on at least one of previous determinations of liquid level of the liquid in the container, previous determinations of a volume of the liquid in the container, or previous aspirations of the liquid from the container, and/or the like.

According to some embodiments, the automated pipettor 115 might be configured, using a first type of actuation, to push air through the pipette tip and might be configured, using a second type of actuation different from the first type of actuation, to move a syringe and the pipette tip that is affixed to the syringe downward toward the container. The apparatus might further be configured to distinguish pressure spikes corresponding to the first type of actuation from pressure spikes corresponding to the second type of actuation and to aspirate the liquid from the container when a series of pressure spikes caused by the first type of actuation exhibits the repetition pattern indicative of the pipette tip making contact with the liquid in the container. In some instances, the automated pipettor might further comprise a plunger motor (for example, first motor 165a, or the like) and a Z-axis motor (for example, second 165b, or the like), wherein the plunger motor causes the first type of actuation, while the Z-axis motor causes the second type of actuation, wherein the first type of actuation and the second type of actuation are distinguishable from each other based on one of the following: the plunger motor comprises a servo motor, while the Z-axis motor comprises a stepper motor; the plunger motor comprises a stepper motor, while the Z-axis motor comprises a servo motor; the plunger motor and the Z-axis motor are both stepper motors, wherein a first pressure curve resultant from at least one of characteristics of the pipette tip or characteristics of the Z-axis motor that influence how the pipette tip moves is different from a second pressure curve resultant from at least one of characteristics of the plunger or characteristics of the plunger motor that influence how the plunger moves; or the plunger motor and the Z-axis motor are both servo motors, wherein a third pressure curve resultant from at least one of characteristics of the pipette tip or characteristics of the Z-axis motor that influence how the pipette tip moves is different from a fourth pressure curve resultant from at least one of characteristics of the plunger or characteristics of the plunger motor that influence how the plunger moves; wherein the characteristics of the pipette tip comprise an outer diameter of the pipette tip, wherein the characteristics of the Z-axis motor comprise at least one of type of motor, control of motor, or transmission between the motor and the pipette tip, and/or the like, wherein the characteristics of the plunger comprise a diameter of the plunger, wherein the characteristics of the plunger motor comprise at least one of type of motor, control of motor, or transmission between the motor and the plunger, and/or the like.

In some embodiments, the automated pipettor, for example by using the computing system, might determine a liquid level of the liquid in the container based on the determined repetition pattern exhibited by the pressure spikes as the pipette tip is moved within the container and based on an indication that the pipette tip has made contact with the liquid in the container.

In some embodiments, determining the liquid level of the liquid in the container might comprise determining a liquid level of the liquid in the container based at least in part on one or more of geometry of the container, height of the container, a distance between a reference point on the container and a reference point on the automated pipettor, height of the pipette tip relative to the reference point on the container, position of the pipette tip as the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, determining the liquid level of the liquid in the container might comprise determining a volume of the liquid in the container based at least in part on one or more of geometry of the container, height of the container, a distance between a reference point on the container and a reference point on the automated pipettor, height of the pipette tip relative to the reference point on the container, position of the pipette tip as the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, determining the liquid level of the liquid in the container might comprise determining a time at which the pipette tip made contact with the surface of the liquid in the container, the determined time corresponding to a start of the repetition pattern. In such cases, causing the automated pipettor to perform one or more tasks might comprise causing the automated pipettor to perform one or more tasks based on the determined time at which the pipette tip made contact with the surface of the liquid in the container.

According to some embodiments, the automated pipettor, for example by using the computing system, might analyze the received air pressure measurements to determine whether the pipette tip has made contact with foam that has accumulated above the surface of the liquid in the container, in some cases, by identifying, from the air pressure measurements, pressure measurements or a series of pressure spikes that is indicative of the pipette tip making contact with foam that has accumulated above the surface of the liquid in the container (such as depicted, for example, by pressure measurements or series of pressure spikes 325 in FIG. 3C, or the like, which corresponds to the pipette tip 260 making contact with foam 285 that has accumulated above the surface 280a of the liquid 280 in container 270b as depicted in FIG. 2C, or the like), said pressure measurements or series of pressure spikes comprising pressure peaks having periods between adjacent pressure peaks that are different from each other. In response to identifying said pressure measurements or series of pressure spikes, the automated pipettor, for example by using the computing system, might dismiss said pressure measurements or series of pressure spikes in determining the liquid level of the liquid in the container. In some embodiments, the computing system might prevent the automated pipettor 115 (and/or the automated pipettor 115 might be configured to prevent) from aspirating any liquid when a series of pressure spikes exhibits a lack of a regular repetition pattern, indicative of the pipette tip making contact with foam in the container.

Alternatively, or additionally, the automated pipettor, for example by using the computing system, might analyze the received air pressure measurements to determine whether the pipette tip has passed through a partially sealed septum of the container but not yet contacted liquid (i.e., has moved into an air-filled region between the wet septum seal and the surface of the liquid in the container), in some cases, by identifying, from the air pressure measurements, pressure measurements or a series of pressure spikes, each pressure spike in the series of pressure spikes having a slope value that is less than a predetermined threshold slope value, indicative of the pipette tip having passed through a partially sealed septum of the container but not yet contacted liquid (such as depicted, for example, by pressure measurements or series of pressure spikes 345 in FIG. 3D, or the like, which corresponds to the pipette tip 260 moving past the wet top seal or septum seal 275 of FIG. 2D so that the pipette tip 260 is between the wet septum seal 275 and the surface 280a of the liquid 280 in liquid container 270c (as shown in FIG. 2E), or the like), said pressure profile comprising consecutive pressure peaks having periods between adjacent pressure peaks that are substantially identical to each other or that are identical to each other to within a predetermined threshold error value (which might include, but is not limited to, one of about 10 ms, about 20 ms, about 30 ms, about 40 ms, about 50 ms, about 60 ms, about 70 ms, about 80 ms, about 90 ms, about 100 ms, about 125 ms, about 150 ms, about 175 ms, about 200 ms, about 225 ms, about 250 ms, about 275 ms, about 300 ms, about 325 ms, about 350 ms, about 375 ms, about 400 ms, about 425 ms, about 450 ms, about 475 ms, about 500 ms, or the like, or a threshold error value in a range between about 1 ms and about 500 ms). In response to identifying said pressure measurements or series of pressure spikes, the automated pipettor, for example by using the computing system, might dismiss said pressure measurements or series of pressure spikes in determining the liquid level of the liquid in the container. According to some embodiments, the computing system might prevent the automated pipettor 115 (and/or the automated pipettor 115 might be configured to prevent) from aspirating any liquid when each pressure spike in a series of pressure spikes has a slope value that is less than a predetermined threshold slope value, indicative of the pipette tip having passed through a partially sealed septum of the container but not yet contacted liquid.

According to some embodiments, the computing system might cause the automated pipettor 115 (and/or the automated pipettor 115 might be configured) to move the pipette tip from a position above the container to a second position along an X-Y plane an X-Y plane that is parallel to a workspace surface on which the base is disposed, by sending third command instructions to an X-Y stage (for example, X-Y stage 165c, or the like) to cause the syringe to move to the second position along the X-Y plane. In this manner, the automated pipettor 115 may align the pipette tip directly above a container or may move the pipette tip from above one container to above another container, prior to lowering the pipette tip into the selected container.

These and other functions of the system 100 (and its components) are described in greater detail below with respect to FIGS. 2-6.

FIGS. 2A-2E (collectively, “FIG. 2”) are schematic diagrams illustrating a system 200 for implementing pressure-based liquid level detection that takes into account presence of foam, wet septum seals on a container, and/or pressure changes caused by a pipette tip having passed through a partially sealed septum of a container, in accordance with various embodiments.

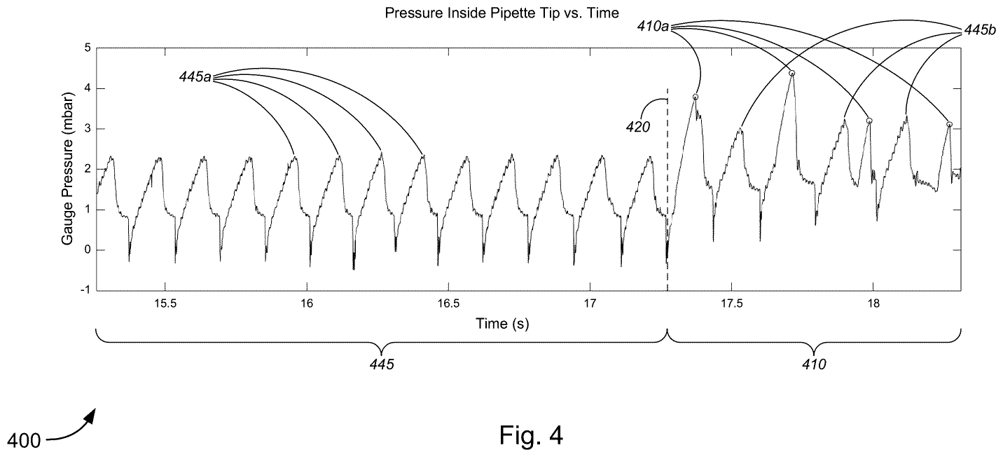

With reference to FIGS. 2A-2E, system 200 might comprise an automated pipettor 205, which might include, but is not limited to, a base 210, a support structure or frame 210a, a controller or computing system 215, an X-Y stage comprising an X-direction motor 220 configured to rotate a threaded screw 220a about a first axis that is parallel to the X-axis (as denoted by the X-axis arrow in FIG. 2) and a Y-direction motor 225 configured to rotate a threaded screw 225a about a second axis that is parallel to the Y-axis (which would extend into and out of each drawing sheet of FIG. 2), and a Z-direction motor 230 configured to rotate a threaded screw 230a about a third axis that is parallel to the Z-axis (as denoted by the Z-axis arrow in FIG. 2). Herein, the combination of the X-Y stage and the Z-direction motor, and components thereof, may be referred to as an X-Y-Z stage. The automated pipettor 205 might further include, without limitation, a syringe holder or platform 235, which might be used to hold or secure a syringe 240 within the X-Y-Z stage. The platform 235 may also be used to mount a plunger motor 245 configured to rotate a threaded screw 245a about a fourth axis that is parallel to the Z-axis to cause a plunger actuator 250a that is attached to plunger 250 to move upward or downward along the screw 245a, which causes the plunger 250 to correspondingly move upward or downward relative to the body of the syringe 240. Herein, the plunger motor 245 and the Z-direction motor 230 are also respectively referred to in the claims and in FIGS. 1 and 4 as the first motor configured to cause the plunger to move upward or downward relative to the syringe body and the second motor configured to cause the syringe to move upward or downward relative to the base 210 (or other fixed reference point on the automated pipettor 205).

The platform 235 may also be used to mount a pressure sensor 255 that monitors air pressure within the syringe 240. As shown in FIG. 2, the pressure sensor 255 might be a gauge pressure sensor that measures the gauge pressure, which is defined by one of relative pressure, differential pressure, or actual (or absolute) pressure minus atmospheric pressure, or the like. System 200 might further comprise one or more pipette tips 260 that may be attached or affixed to syringe 240 (either removably or permanently), a container holder 265 having openings 265a through which a pipette tip 260 (when attached or affixed to syringe 240) can access one or more containers 270a-270d, septum seals, top seals, or other container lids or seals 275, and/or liquid 280 in the one or more containers 270a-270d. Although not shown in FIG. 2, the computing system 215 might communicatively couple with each of the X-direction motor 220, the Y-direction motor 225, the Z-direction motor 230, the plunger motor 245, and the pressure sensor 255, either via wired or via wireless connection. Also not shown, the computing system 215 may also be communicatively coupled with an external computing system (for example, computing system 105a or 105b, or user device(s) 125 of FIG. 1, or the like), a user interface device(s), or the like, either via wired or via wireless connection.

As shown in FIG. 2, the platform 235 may be movably attached to screw 230a, such that, when Z-direction motor 230 rotates screw 230a about the third axis that is parallel to the Z-axis, the platform 235 (as well as the syringe 240, the plunger motor 245, the plunger actuator 250a, the plunger 250, and the pressure sensor 255, which are directly or indirectly mounted to platform 235) is caused to move upward or downward along the screw 230a [thereby causing the syringe 240 and pipette tip 260 (when attached or affixed to syringe 240) to move upward or downward relative to base 210 or some other fixed reference point on the automated pipettor 205, or to move along the Z-direction]. Likewise, the Z-direction motor 230 may be movably attached to screw 220a, such that, when the X-direction motor 220 rotates screw 220a about the first axis that is parallel to the X-axis, the Z-direction motor 230, the screw 230a, and the platform 235 (as well as the syringe 240, the plunger motor 245, the plunger actuator 250a, the plunger 250, and the pressure sensor 255, which are directly or indirectly mounted to platform 235) are caused to move laterally along the screw 220a [thereby causing the syringe 240 and pipette tip 260 (when attached or affixed to syringe 240) to move laterally along the X-axis relative to base 210 or relative to some other fixed reference point on the automated pipettor 205].

Similarly, the X-direction motor 220 may be movably attached to screw 225a, such that, when the Y-direction motor 225 rotates screw 225a about the second axis that is parallel to the Y-axis, the X-direction motor 220, the screw 220a, the Z-direction motor 230, the screw 230a, and the platform 235 (as well as the syringe 240, the plunger motor 245, the plunger actuator 250a, the plunger 250, and the pressure sensor 255, which are directly or indirectly mounted to platform 235) are caused to move laterally along the screw 225a [thereby causing the syringe 240 and pipette tip 260 (when attached or affixed to syringe 240) to move laterally along the Y-axis relative to base 210 or relative to some other fixed reference point on the automated pipettor 205]. Although FIG. 2 depicts such an X-Y-Z stage, the various embodiments are not so limited, and the Z-stage (comprising the Z-direction motor 230 and the screw 230a) might be movably attached to the Y-stage (instead of the X-stage as shown in FIG. 2), while the Y-stage is movably attached to the X-stage, with the X-stage being mounted to frame 210a. Alternatively, any other configuration of the X-Y-Z stage or X-Y-Z functionality may be implemented as appropriate or as desired to enable the syringe or the pipette tip (when attached or affixed to the syringe) to move in one or more of the X-direction, the Y-direction, and/or the Z-direction relative to base 210 of the automated pipettor 205 or some other fixed reference point on the automated pipettor 205, or relative to a container that is placed within the system or that is placed within or below automated pipettor 205.

In some embodiments, a pipette tip 260 among the one or more pipette tips 260 might include, without limitation, metal pipette tips, plastic pipette tips, glass pipette tips, or the like. In some cases, pipette tips 260 may either be cleaned after touching any part of a container 270, a septum seal, a top seal, or other container lid or seal 275 of the container 270, and/or liquid 280 in the container 270, or the like, or (if removably attached) may be disposed of to be replaced by (new and) clean pipette tips 260, using a pipette tip dispenser or exchanger system (shown in FIG. 1, but not shown in FIG. 2).

In operation, computing system 215 or an external computing system (for example, computing system 105a, remote computing system 105b, and/or user device(s) 125 of FIG. 1, or the like) (collectively, “controller” or the like) might cause automated pipettor 205 to lower a pipette tip (for example, pipette tip 260, or the like) that is attached to a syringe (for example, syringe 240, or the like) of the automated pipettor 205 into a container (for example, container 270 among the one or more containers 270a-270d, or the like) while simultaneously causing a plunger of the syringe (for example, plunger 250 of syringe 240, or the like) to push or dispense air out of the pipette tip (for example, pipette tip 260, or the like). With reference to FIG. 2, these functions may be performed, for example, by the controller sending control signals to each of the X-direction motor 220 and the Y-direction motor 225 to cause the X-direction motor 220 and the Y-direction motor 225 to respectively rotate the screws 220a and 225a to cause the Z-direction motor 230 and the screw 230a attached thereto to move laterally in the X-direction and in the Y-direction such that the pipette tip 260—which is attached or affixed to the syringe 240 that itself is held or mounted to platform 240, which is movably attached to screw 230a—is positioned above the (identified or selected) container. To determine the relative position of the identified or selected container within (or below) the automated pipettor 205, sensors (for example, camera(s) (shown in FIG. 1) or other sensors, or the like) may be used, perhaps in conjunction with mapped coordinates of one or more of the (relative) position of the container holder 265, the (relative) position of each of the openings 265a, or the (relative) position of each container 270 within the container holder 265, and/or the like.

The controller might then send control signals to each of the Z-direction motor 230 and the plunger motor 245 to cause the Z-direction motor 230 and the plunger motor 245 to respectively rotate screws 230a and 245a to cause the platform 240 to move downward in the Z-direction such that the pipette tip 260 is lowered toward (and eventually into) the (identified or selected) container, while the plunger actuator 250a is caused to slowly lower along the Z-direction thereby slowly pushing the plunger 250 downward in the Z-direction within the body of the syringe 240 (which results in air being pushed out of the syringe 240 through the pipette tip 260).

In some cases, the pipette tip 260 might be used to aspirate at least a portion of the liquid from one container among the containers 270a-270d (by the plunger motor 245 causing the plunger actuator 245a to cause the plunger 250 to move upward along the Z-direction or to move upward within the body of the syringe 240, thereby resulting in negative pressure within the syringe 240 and the pipette tip 260, which causes liquid to be drawn into the pipette tip 260), then (if permanently attached to the syringe 240) may be cleaned in preparation for aspirating liquid from a different container 270a-270d, or (if removably attached to the syringe 240) may be subsequently disposed of using a pipette tip dispenser or exchanger or the like (not shown in FIG. 2), with a new (and unused) pipette tip among the pipette tips 260 being affixed to the syringe 240 (in some cases, using the pipette tip dispenser or exchanger or the like) in preparation for aspirating liquid from a different container 270a-270d. By using different pipette tips with different liquids or with different containers (regardless of whether the same liquid is in multiple containers that are used), cross-contamination may be limited or avoided, and, with the use of clean or new pipette tips, “clean” pressure measurements can be assured (assuming no liquid ever aspirates or enters the syringe 240, and rather remains only in the pipette tips 260), thereby allowing for more accurate and precise pressure-based liquid level detection (as described in detail below). Some automated pipettors, however, are designed with fixed or permanent pipette tips, in which case, cleaning cycles between aspirations are used to ensure “clean” pressure measurements for successive operations.

The controller might receive air pressure measurements (whether continuously, periodically, randomly, or in response to commands for pressure measurements, or the like) from a pressure sensor (for example, pressure sensor 255, or the like) that monitors air pressure within the syringe (for example, syringe 240, or the like), as the automated pipettor 205 is caused to lower the pipette tip (for example, pipette tip 260, or the like) into the container (for example, container 270a-270d, or the like), as described above. By analyzing the received air pressure measurements, the controller is able to determine whether the pipette tip has not yet made contact with anything (such as shown in FIG. 2A, with corresponding pressure measurements 305 shown, for example, in FIG. 3A, or the like), to determine whether the pipette tip has made contact with the liquid in the container (such as shown in FIG. 2B, with the pipette tip 260 making contact with (the surface 280a of) liquid 280 in container 270b, with corresponding pressure measurements or series of pressure spikes 310 shown, for example, in FIG. 3B, or the like), to determine whether the pipette tip has made contact with foam that has accumulated above the surface of the liquid in the container (such as shown in FIG. 2C, with the pipette tip 260 making contact with foam 285 that has accumulated above the surface 280a of liquid 280 in container 270b, with corresponding pressure measurements or series of pressure spikes 325 shown in FIG. 3C, or the like), to determine whether the pipette tip has made contact with a wet septum seal or a septum seal of the container that is wet with liquid from within the container (perhaps due to transfer leakage after the liquid has previously been aspirated from the container, or the like) that covers the septum seal (such as shown in FIG. 2D, with the pipette tip 260 making contact with the septum seal 275 of container 270c that is wet with liquid 290, with corresponding pressure measurements or series of pressure spikes 335 shown in FIG. 3D, or the like), or to determine whether the pipette tip has passed through a partially sealed septum but not yet contacted liquid in the container (such as shown in FIG. 2E, with the pipette tip 260 having passed through the partially sealed septum 275 into air-filled region 295 between the septum seal 275 of container 270c that is wet with liquid 290 and the surface 280a of liquid 280 in container 270c, with corresponding pressure measurements or series of pressure spikes 345 shown in FIG. 3D, or the like), and/or the like.

The controller might determine at least one of that the pipette tip is making contact with liquid in the container, a liquid level of the liquid in the container, a volume of the liquid in the container, or a time at which the pipette tip makes contact with the liquid in the container, and/or the like, in some cases, by identifying, from the pressure measurements, a series of pressure spikes that exhibits a repetition pattern indicative of the pipette tip making contact with the surface of the liquid (such as, but not limited to, the repetition patterns in pressure measurements or series of pressure spikes 310 or 310′ shown in FIGS. 3B-3D, or the like) [herein referred to as the “liquid contact condition” or the like], while ignoring the pressure measurements or series of pressure spikes that exhibit a lack of a regular repetition pattern, indicative of the pipette tip making contact with foam (such as, but not limited to, pressure measurements or series of pressure spikes 325 shown in FIG. 3C, or the like) [herein also referred to as the “foam condition” or the like], and/or the pressure measurements or series of pressure spikes having a repetition pattern that is obtained around a known or suspected location or height of the septum, indicative of the pipette tip making contact with a wet septum seal (such as, but not limited to, pressure measurements 335 shown in FIG. 3D, or the like) [herein also referred to as the “wet septum contact condition” or the like], and/or the pressure measurements or series of pressure spikes, each pressure spike in the series of pressure spikes having a slope value that is less than a predetermined threshold slope value, indicative of the pipette tip having passed through a partially sealed septum into an air-filled region between the wet septum seal and the surface of the liquid in the container (such as, but not limited to, pressure measurements or series of pressure spikes 345 shown in FIG. 3D, or the like) [herein referred to as the “partially sealed septum condition” or the like], and/or the like. Based on a determination as to at least one of that the pipette tip is making contact with liquid in the container, the liquid level of the liquid in the container, the volume of the liquid in the container, or the time at which the pipette tip makes contact with the liquid in the container, and/or the like, the controller might cause the automated pipettor to perform one or more tasks.

Merely by way of example, in some cases, performing the one or more tasks might comprise, based on a determination that the container contains an amount of liquid greater than a predetermined amount of liquid, aspirating the predetermined amount of liquid from the container and transferring the aspirated liquid to a receptacle (which might include, but is not limited to, one of a microscope slide or another container, or the like). Alternatively, or additionally, performing the one or more tasks might comprise, based on a determination that the container contains an amount of liquid less than the predetermined amount of liquid, performing one of: aspirating a remaining amount of liquid from the container, moving the pipette tip to a second container containing the same liquid, aspirating an amount of liquid from the second container so that the total amount of liquid in the pipette tip equals the predetermined amount of liquid, and transferring the aspirated liquid to the receptacle; moving the pipette tip to the second container containing the same liquid, aspirating the predetermined amount of liquid from the second container, and transferring the aspirated liquid to the receptacle; or sending or displaying a notification to a user to replace the container with another container having an amount of the same liquid that is greater than the predetermined amount of liquid. Alternatively, or additionally, performing the one or more tasks might comprise, based on a determination as to how many more aspirations of liquid can be obtained from the container based on the determined liquid level, sending or displaying a notification to the user indicating a determined number of remaining aspirations of liquid that can be obtained from the container. Alternatively, or additionally, performing the one or more tasks might comprise, based on a determination as to remaining volume of liquid that is in the container based on the determined liquid level, sending or displaying a notification to the user indicating the determined remaining volume of liquid that is in the container.

In some embodiments, determining the liquid level of the liquid in the container might comprise determining, with the controller, a liquid level of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

In a non-limiting example, with reference to FIG. 2B, one way to determine liquid level within a container might be to determine fixed heights and distances, and to determine the position of the platform 235 along the screw 230a. That is, knowing the fixed distance h₁ from the top surface of base 210 to the middle of screw 220a, the fixed distance h₂ between the middle of screw 220a to the lower end of screw 230a, the fixed distance h₄ between the middle of platform 235 and the orifice of the pipette tip 260, the fixed height h₅ from the top surface of base 210 to the bottom of the internal portion of each container 270, and by determining the position h₃ of the middle of platform relative to the lower end of screw 230a, one can determine the height h₆ of orifice of the pipette tip 260 relative to the bottom of the internal portion of a particular container 270 into which the pipette tip 260 may be lowered. The height h₆ at the time that the controller identifies pressure measurements or a series of pressure spikes that exhibits a repetition pattern that is indicative of the pipette tip making contact with (the surface of) the liquid (such as pressure measurements or series of pressure spikes 310 or 310′ shown in FIGS. 3B-3D, or the like) would thus correspond to the level of the liquid in the container. In other words, referring to FIG. 2B, h₆ would equal h₁ minus h₅ minus h₂ minus h₄ plus h₃. Alternatively, rather than using h₂ and h₃, one can determine the position h₃′ of the middle of platform relative to the middle of screw 220a. In such a case, h₆ would equal h₁ minus h₅ minus h₃′ minus h₄. In other alternative embodiments, other relative distances and heights may be used to determine or calculate height h₆.

Alternatively, or additionally, rather than knowing or determining the specific liquid level of the liquid in the container, it may be sufficient to know or determine when the pipette tip makes contact with the liquid in the container. In such cases, determining the liquid level of the liquid in the container might comprise determining, with the controller, a time at which the pipette tip made contact with the liquid in the container, the determined time corresponding to a start of the repetition pattern. Accordingly, causing, with the controller, the automated pipettor to perform one or more tasks might comprise causing, with the computing system, the automated pipettor to perform one or more tasks based on the determined time at which the pipette tip made contact with the surface of the liquid in the container.

By knowing the relative position of any one of the platform 235, the orifice of the pipette tip 260, or the like, in relation to the time, by determining the time, one can determine the height of the orifice of the pipette tip at that determined time, and can thus calculate the height h₆ at that determined time to determine the liquid level within the container. Alternatively, or additionally, knowing the relative position of the platform 235, the orifice of the pipette tip 260, or the like, at a reference time (for example, time 0 s, or the like), and knowing the speed at which the platform 235, the orifice of the pipette tip 260, or the like, is lowered, using the determined time corresponding to the start of the repetition pattern, one can calculate the height h₆ at that determined time to determine the liquid level of the liquid in the container. In some embodiments, the platform 235, the orifice of the pipette tip 260, or the like may be lowered at a speed of 1, 2, 3, 4, 5, 10, 15, 20, 25, or 30 mm/s, or the like, or at a speed ranging between 1 and 30 mm/s, while the plunger motor 245 causes the plunger actuator 245a to cause the plunger 250 to lower relative to the syringe 240 at a speed of 10, 20, 30, 40, 50, 60, 70, 80, 90, or 100 μL/s, or the like, or at a speed ranging between 1 and 100 μL/s.

Alternatively, or additionally, determining a liquid level of the liquid in the container might comprise determining, with the controller, a volume of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

In such cases, determining the level of the liquid in the container as described above (i.e., by determining the position h₆, as shown in FIG. 2B, at the time that the controller identifies a leading edge of the repetition pattern that is indicative of the pipette tip making contact with the liquid (such as pressure measurements or series of pressure spikes 310 or 310′ shown in FIGS. 3B-3D, or the like), or the like), and by knowing the internal width and depth dimensions of the container (or knowing the inner diameter of a cylindrical container or knowing the internal cross-sectional area of a container having other polygonal shape), the volume of the liquid in the container may be calculated.

The various embodiments allow for detection of liquid level, while taking into account the possibility of the pipette tip being sealed at a wet septum and/or the possibility that foam could be present above the liquid's surface. Sufficient information may be present within a single pressure spike—such that detection algorithms can be based on a single pressure spike —, but preferably two or more (for example, four or five) pressure spikes may be included to enhance detection robustness. Features of the pressure spike may include the following. If P corresponds to pressure, then the time rate of change in pressure (i.e., dP/dt) depends on a volume monitored by a sensor. When the pipette tip is above the liquid's surface, without a liquid seal at the septum of the container (i.e., without a wet septum seal), dP/dt would equal 0. When the pipette tip is in the liquid, volume is small, and dP/dt becomes large. When the pipette tip is above the liquid's surface, with a wet septum seal, the volume is large, and dP/dt becomes small. When in foam, time is longer and random.

As the pipette tip passes through a wet septum seal or through a partially sealed septum, pressure spikes like when in liquid may be obtained. The wet septum peaks or partially sealed septum peaks may be filtered either by tip position or by recognizing pressure measurements or series of pressure spikes changing after the pipette tip has passed through a partially sealed septum (for example, the wet septum seal, or the like) but not yet contacted liquid.

Further, these features of the pressure measurements may be dependent on the relative motion of two motors, namely, the Z-axis motor and the plunger axis motor. Varying the movement of those motors, either in a predetermined way or in reaction to features of the pressure measurements or series of pressure spikes can lead to further insights regarding the location of the pipette tip. For example, as shown in the non-limiting example of FIG. 4, using a first type of actuation to push air through the pipette tip and using a second type of actuation different from the first type of actuation to move a syringe and the pipette tip that is affixed to the syringe downward toward the container could help one to distinguish between partially sealed septum peaks and liquid peaks. In some cases, by distinguishing pressure spikes corresponding to the first type of actuation from pressure spikes corresponding to the second type of actuation, the controller can aspirate the liquid from the container when a series of pressure spikes caused by the first type of actuation exhibits the repetition pattern indicative of the pipette tip making contact with the liquid in the container, or the like.

According to some embodiments, trending on liquid height may be used to enhance robust detection. Based on liquid height decay as liquid is aspirated from the container (for example, a vial, or the like), one can narrow the acceptable range for new liquid height. In some embodiments, knowing the bottom of a container relative to the surface of the liquid in the container may allow for better estimation of the volume in the container (or vial), as well as a reduction in a container dead volume. According to some embodiments, aspiration and dispensing control may be used to secure the correct volume dispensed at a target. Pressure measurements or series of pressure spikes allow for detection errors during aspiration, movement, and/or dispensing.

Merely by way of example, in some cases, rather than using plunger movement to generate air movement out of the pipette tip, such air movement may be generated using a pressurized air source, a pump, or some other system.

These and other functions of the system 200 (and its components) are described in greater detail with respect to FIGS. 1, 3, and 4.

FIGS. 3A-3D (collectively, “FIG. 3”) are graphical diagrams illustrating non-limiting examples 300, 300′, 300″, and 300″ of pressure measurements over time corresponding to pressure-based liquid level detection and container conditions as depicted in FIGS. 2A-2E, in accordance with various embodiments.

In the non-limiting example 300 of FIG. 3A, pressure measurements 305 is shown that is indicative of the syringe or the pipette tip of the automated pipettor being exposed to one of air pressure or starting pressure (with the gauge pressure reading being less than about 0.2 mbar, where gauge pressure is defined by one of relative pressure, differential pressure, or actual (or absolute) pressure minus atmospheric pressure) prior to the pipette tip encountering any of the septum or fluids in the container. Such a pressure measurements or series of pressure spikes would correspond to the relative position of the orifice of the pipette tip 260 as shown in FIG. 2A, for instance.

Turning to the non-limiting example 300′ of FIG. 3B, pressure measurements or series of pressure spikes 305, 310, and 315 are shown. Pressure measurements or series of pressure spikes 305 (like in FIG. 3A) would correspond to the orifice of the pipette tip 260 being exposed to one of air pressure or starting pressure prior to the pipette tip encountering any of the septum or fluids in the container, as shown in FIG. 2A, for instance. Pressure measurements or series of pressure spikes 310 would correspond to the orifice of the pipette tip 260 making contact with the surface 280a of the liquid 280 in container 270b, as depicted in FIG. 2B. As shown in FIG. 2B, for instance, when the pipette tip 260 makes contact with the surface 280a of the liquid 280 in container 270b, bubbles are formed and released within the container, due to the air being pushed out of the syringe 240 and the pipette tip 260 by the plunger motor 245 causing the plunger actuator 250a to push downward on the plunger 250 within the body of the syringe 240. This results in pressure measurements or series of pressure spikes 310, which comprises a plurality of (for example, at least four) consecutive pressure peaks 310a (in some cases, at least five consecutive pressure peaks) having periods P₁-P_{N} (P₁-P₄ or P₁-P₅) between adjacent pressure peaks that are substantially identical to each other to within a first predetermined threshold error value (which might include, but is not limited to, one of about 10 ms, about 20 ms, about 30 ms, about 40 ms, about 50 ms, about 60 ms, about 70 ms, about 80 ms, about 90 ms, about 100 ms, about 125 ms, about 150 ms, about 175 ms, about 200 ms, about 225 ms, about 250 ms, about 275 ms, about 300 ms, about 325 ms, about 350 ms, about 375 ms, about 400 ms, about 425 ms, about 450 ms, about 475 ms, about 500 ms, or the like), where pressure valleys 310b between the plurality of (for example, at least four or at least five) consecutive pressure peaks 310a each has a pressure value that is greater than ambient pressure (which is depicted in FIG. 3 as being at a gauge pressure of about 0 mbar). As shown in FIG. 3B, periods P₁-P₄ (or P₁-P₅) are very similar, if not substantially identical, to each other to within the first predetermined threshold error value. The presence of such repetition pattern (or similar repetition pattern) is indicative of the pipette tip making contact with liquid in the container.

In FIG. 3B, the dashed line 320, which is located at the leading edge of the first pressure peak 310a of measurements or series of pressure spikes 310 (or more specifically at the leading pressure valley of curve of 310) or at the leading edge or start of the repetition pattern, corresponds to the time that the pipette tip 260 makes contact with (the surface 280a of) the liquid 280 in container 270b, as depicted in FIG. 2B. As discussed above, knowing this time, together with knowing the relative position of the platform 235, the orifice of the pipette tip 260, or the like, one can determine the liquid level (for example, height h₆, or the like) of the liquid 280 in the container 270b. Alternatively, or additionally, knowing the relative position of the platform 235, the orifice of the pipette tip 260, or the like, at a reference time (for example, time 0 s, or the like), and knowing the speed at which the platform 235, the orifice of the pipette tip 260, or the like is lowered, using the determined time corresponding to the leading pressure valley or leading edge of the pressure measurements or series of pressure spikes 310, one can calculate the height h₆ at that determined time to determine the liquid level of the liquid in the container. Alternatively, or additionally, knowing the height h₆ at that determined time to determine the liquid level within the container and knowing the internal cross-sectional area of the container, one can determine or calculate the remaining volume of liquid in the container. In some embodiments, the platform 235, the orifice of the pipette tip 260, or the like, may be lowered at a speed of 1, 2, 3, 4, 5, 10, 15, 20, 25, or 30 mm/s, or the like, or at a speed ranging between 1 and 30 mm/s, while the plunger motor 245 causes the plunger actuator 245a to cause the plunger 250 to lower relative to the syringe 240 at a speed of 10, 20, 30, 40, 50, 60, 70, 80, 90, or 100 μL/s, or the like, or at a speed ranging between 1 and 100 μL/s.

With reference to FIG. 3C, pressure measurements or series of pressure spikes 305, 310, and 325 are shown. As discussed above, pressure measurements or series of pressure spikes 305 and 310 correspond, respectively, to the orifice of the pipette tip 260 being exposed to one of air pressure or starting pressure prior to the pipette tip encountering any of the septum or fluids in the container, as shown in FIG. 2A, for instance, and the pipette tip 260 making contact with (the surface 280a of) the liquid 280 in container 270b, as shown in FIG. 2B, for instance. Pressure measurements or series of pressure spikes 325 may, in some cases (though not all cases), correspond to the pipette tip 260 making contact with foam accumulating at or above the surface of the liquid in the container. As shown in FIG. 2C, for instance, when the pipette tip 260 makes contact with foam 285 accumulating on or above the surface 280a of liquid 280 in container 270b, due to the air being pushed out of the pipette tip 260 by the plunger motor 245 lowering the plunger 250 within the body of the syringe 240, the pressure as measured by the pressure sensor would spike when the orifice of the pipette tip 260 presses against the wall of a bubble, and drops when the bubble bursts or expands. This results in pressure measurements or series of pressure spikes 325, which comprises pressure peaks 325a and pressure valleys 325b, with the pressure peaks 325a having periods P₁ and P₂ between adjacent pressure peaks 325a that are different from each other. In other words, the series of pressure spikes 325 exhibits a lack of a regular repetition pattern, indicative of the pipette tip making contact with foam in the container.

In FIG. 3C, the dashed line 330, which is located at the leading edge of the first pressure peak 325a of curve 325 (or more specifically the leading pressure valley of curve 325) corresponds to the time that the pipette tip 260 makes contact with the layer of foam accumulating on or above the surface 280a of the liquid 280 in container 270b, as depicted in FIG. 2C. By determining that the pipette tip 260 is in the foam layer and not making contact with the surface of the liquid, curve 325 can be dismissed or ignored when determining the liquid level within the container.

As discussed above with respect to FIG. 3B, in FIG. 3C, the dashed line 320—which is located at the leading edge of the first pressure peak 310a of measurements or series of pressure spikes 310 (or more specifically at the leading pressure valley of curve of 310) or at the leading edge or start of the repetition pattern—corresponds to the time that the pipette tip 260 makes contact with (the surface 280a of) the liquid 280 in container 270b, as depicted in FIG. 2B. As discussed above, alternative or additional to the repetition pattern of pressure measurements or pressure spikes of 310a, the height of the liquid in the container and/or the time at which the pipette tip made contact with the liquid may be used to determine the liquid level. As also discussed above, knowing the height h₆ at that determined time to determine the liquid level within the container and knowing the internal cross-sectional area of the container, one can determine or calculate the remaining volume of liquid in the container.

Referring to FIG. 3D, pressure measurements or series of pressure spikes 305, 310′, 335, and 345 are shown. As discussed above, pressure measurements or series of pressure spikes 305 and 310′ correspond, respectively, to the orifice of the pipette tip 260 being exposed to one of air pressure or starting pressure prior to the pipette tip encountering any of the septum or fluids in the container, as shown in FIG. 2A, for instance, and the pipette tip 260 making contact with (the surface 280a of) the liquid 280 in container 270b, as shown in FIG. 2B, for instance. Pressure measurements or series of pressure spikes 335 may, in some cases (though not all cases), correspond to the pipette tip making contact with the liquid that has accumulated on the septum seal of the container. As shown in FIG. 2D, for instance, when the pipette tip 260 makes contact with the liquid 290 that has accumulated on the septum seal 290 of the container 270c, due to the air being pushed out of the pipette tip 260 by the plunger motor 245 lowering the plunger 250 within the body of the syringe 240, the pressure as measured by the pressure sensor would spike when the orifice of the pipette tip 260 is blocked by the liquid 290, and might have subsequent pressure peaks that seem to correspond to the pipette tip 260 making contact with the liquid in the container, but is actually just indicative of the orifice of the pipette tip 260 being submerged within the thin liquid layer 290.

In FIG. 3D, the dashed line 340, which is located at the leading edge of the first pressure peak 335a of measurements or series of pressure spikes 335 (or more specifically the leading pressure valley of measurements or series of pressure spikes 335) corresponds to the time that the pipette tip 260 makes contact with the thin layer of liquid 290 accumulating on the septum seal 275 of container 270c, as depicted in FIG. 2D. In some embodiments, the series of pressure spikes 335 might exhibit a regular repetition pattern, but knowing or suspecting that the orifice of the pipette tip is at or near the septum of the container, one can either set the controller to ignore the series of pressure spikes 335 or otherwise dismiss such pressure measurements for the purposes of liquid level detection.

Further, in FIG. 3D, pressure measurements or series of pressure spikes 345 may, in some cases (though not all cases), correspond to the orifice of the pipette tip having passed through a partially sealed septum into the air space or the air-filled region between the partially sealed septum and the surface of the liquid in the container. As shown in FIG. 2D, for instance, below the liquid 290 accumulating on the septum seal 275 of the container 270c (i.e., partially sealed septum, wet septum seal, or the like) and above the surface 280a of the liquid 280 in the container 270c is the air-filled region 295. When the orifice of the pipette tip 260 is lowered past the partially sealed septum into the air-filled region 295 (as shown in FIG. 2E), the pressure as measured by the pressure sensor would spike due to the liquid 290 forming a temporary liquid seal around the wall of the pipette tip 260, but, as air is pushed upward past this temporary liquid seal due to the air being pushed through the syringe 240 by plunger motor 245 causing the plunger 250 to move downward within the body of the syringe 240 and due to the pipette tip 160 moving into the container, pressure drops down to the one of air pressure or starting pressure, followed by the temporary liquid seal reforming (resulting in another spike). This results in pressure measurements or series of pressure spikes 345, which comprises pressure peaks 345a and pressure valleys 345b, with consecutive pressure peaks 345a having periods P₁-P₄ between adjacent pressure peaks 345a that are substantially identical to each other.

In FIG. 3D, the dashed line 350, which is located at the leading edge of the first pressure peak 345a of curve 345 (or more specifically the leading pressure valley of curve 345) corresponds to the time that the orifice of the pipette tip enters the air space or the air-filled region between the partially sealed septum seal and the surface of the liquid in the container (as shown in FIG. 2E).

In some cases, the consecutive pressure peaks 345a of the pressure measurements or series of pressure spikes 345 might each have a slope (denoted by dot-dash line 360) that is significantly less than a slope (denoted by dot-dash line 355) of each of the plurality of (for example, at least four) consecutive pressure peaks 310a of the pressure measurements or series of pressure spikes 310, where the slope of each peak 345a of the pressure measurements or series of pressure spikes 345 might be less than a predetermined threshold slope value (which might include, without limitation, one of about 14 mbar/s, about 16 mbar/s, about 18 mbar/s, about 20 mbar/s, about 22 mbar/s, about 24 mbar/s, about 26 mbar/s, about 28 mbar/s, about 30 mbar/s, or the like, or a threshold slope value in a range between about 1 mbar/s and about 30 mbar/s, or the like) while the slope of each peak 310a of the pressure measurements or series of pressure spikes 310 might be greater than the predetermined threshold slope value. Pressure measurements or series of pressure spikes 345 can thus be identified by comparing the slope of the pressure peaks 345a with the slope of the pressure peaks 310a of pressure measurements or series of pressure spikes 310, or by determining whether the slope of the pressure peaks 345a exceed the predetermined threshold slope value. To ensure that the slope of the pressure peaks 345a does not inadvertently exceed the predetermined threshold slope value, the speed at which the pipette tip is lowered may be decreased, as an increased speed of lowering the pipette tip may create a false positive result if only considering the slope of the pressure peaks 345a.

Alternatively, the outer diameter of the pipette tip may be reduced, which would reduce the slope of a partially sealed septum pressure spike. To increase the slope of both types of pressure spikes (i.e., pressure spikes due to partially sealed septum and pressure spikes due to the actual liquid detection), but with a bigger impact on liquid pressure spikes, one may implement at least one of the following: increasing the speed of the syringe plunger, reducing the internal volume of the pipette tip, and/or reducing the volume of the syringe, or the like. To increase the height of liquid pressure spikes, which helps them to stand out from the noise of the partially sealed septum pressure spikes, the inner diameter of the tip orifice of the pipette tip may be reduced. Any or all of these changes would facilitate liquid level detection. In some embodiments, the platform 235, the orifice of the pipette tip 260, or the like may be lowered at a speed of 1, 2, 3, 4, 5, 10, 15, 20, 25, or 30 mm/s, or at a speed ranging between 1 and 30 mm/s, or the like, while the plunger motor 245 causes the plunger actuator 245a to cause the plunger 250 to lower relative to the syringe 240 at a speed of 10, 20, 30, 40, 50, 60, 70, 80, 90, or 100 μL/s, or the like, or at a speed ranging between 1 and 100 μL/s.

As shown in FIG. 3D, pressure measurements or series of pressure spikes 310′ is a combination of the pressure measurements or series of pressure spikes 310 as shown in FIGS. 3B and 3C and the pressure measurements or series of pressure spikes caused by the pipette tip having passed through the partially sealed septum into the air-filled region between the partially sealed septum and the surface of the liquid in the container (for example, pressure measurements or series of pressure spikes 345). It is nonetheless possible to identify pressure measurements or series of pressure spikes 310′ by identifying characteristics of the pressure measurements or series of pressure spikes as described above—namely, a series of spikes each with a slope 355 that is beyond the predetermined threshold slope value, or a series of pressure spikes, each pressure spike in the series of pressure spikes having a slope value that is less than a predetermined threshold slope value, indicative of the pipette tip having passed through a partially sealed septum of the container but not yet contacted liquid, or the like.

As discussed above with respect to FIGS. 3B and 3C, in FIG. 3D, the dashed line 320—which is located at the leading edge of the first pressure peak 310a of measurements or series of pressure spikes 310 (or more specifically at the leading pressure valley of curve of 310) or at the leading edge or start of the repetition pattern—corresponds to the time that the pipette tip 260 makes contact with (the surface 280a of) the liquid 280 in container 270b, as depicted in FIG. 2B. As discussed above, alternative or additional to the repetition pattern of pressure measurements or pressure spikes of 310a, the height of the liquid in the container and/or the time at which the pipette tip made contact with the liquid may be used to determine the liquid level. As also discussed above, knowing the height h₆ at that determined time to determine the liquid level within the container and knowing the internal cross-sectional area of the container, one can determine or calculate the remaining volume of liquid in the container.

An alternative or additional method for determining whether the pipette tip has made contact with the liquid in the container as opposed to exhibiting effects of a partially sealed septum might utilize different motor configurations for the plunger motor and the Z-axis motor. FIG. 4 is a graphical diagram illustrating a non-limiting example of pressure measurements over time corresponding to pressure-based liquid level detection and container conditions using different motor configurations for a plunger motor and a Z-axis motor, in accordance with various embodiments.

In particular, the system might use a first type of actuation for the plunger motor to push air through the pipette tip and might use a second type of actuation different from the first type of actuation for the Z-axis motor to move the syringe and the pipette tip that is affixed to the syringe downward toward the container. In some embodiments, the plunger motor might comprise a servo motor, while the Z-axis motor might comprise a stepper motor, or vice versa. Alternatively, the plunger motor and the Z-axis motor might both be stepper motors or might both be servo motors, or the like, where a first pressure curve resultant from at least one of characteristics of the pipette tip or characteristics of the Z-axis motor that influence how the pipette tip moves is different from a second pressure curve resultant from at least one of characteristics of the plunger or characteristics of the plunger motor that influence how the plunger moves. In some cases, the characteristics of the pipette tip might comprise an outer diameter of the pipette tip, while the characteristics of the Z-axis motor might comprise at least one of type of motor, control of motor, or transmission between the motor and the pipette tip, and/or the like. In some instances, the characteristics of the plunger might comprise a diameter of the plunger, while the characteristics of the plunger motor might comprise at least one of type of motor, control of motor, or transmission between the motor and the plunger, and/or the like.

By distinguishing pressure spikes corresponding to the first type of actuation from pressure spikes corresponding to the second type of actuation, the controller can determine whether the pipette tip has made contact with the liquid in the container as opposed to exhibiting effects of a partially sealed septum based on such distinction, and can aspirate the liquid from the container when a series of pressure spikes caused by the first type of actuation exhibits the repetition pattern indicative of the pipette tip making contact with the liquid in the container, or the like, and can prevent aspiration of the liquid from the container when a series of pressure spikes caused by the second type of actuation, but not caused by the first type of actuation, is detected.

With reference to the non-limiting example of FIG. 4, pressure measurements or series of pressure spikes 410 and 445 are shown. Pressure measurements or series of pressure spikes 410 correspond to the first type of actuation exhibiting pressure spikes having a repetition pattern indicative of the pipette tip making contact with the liquid in the container, while pressure measures or series of pressure spikes 445 correspond to the second type of actuation exhibiting pressure spikes having a repetition pattern indicative of the pipette tip having passed through a partially sealed septum. As shown in the non-limiting embodiment of FIG. 4, as a result of the Z-axis motor having a different actuation from the plunger motor (whether being different types of motors or whether a first pressure curve resultant from at least one of characteristics of the pipette tip (e.g., outer diameter of the pipette tip, etc.) or characteristics of the Z-axis motor (e.g., at least one of type of motor, control of motor, or transmission between the motor and the pipette tip, or the like) that influence how the pipette tip moves is different from a second pressure curve resultant from at least one of characteristics of the plunger (e.g., diameter of the plunger, etc.) or characteristics of the plunger motor (e.g., at least one of type of motor, control of motor, or transmission between the motor and the plunger, or the like) that influence how the plunger moves), the pressure spikes 445a or 445b caused by the second actuation of the Z-axis motor exhibit visually distinct lack of smoothness compared with the pressure spikes 410a caused by the first actuation of the plunger motor.

Further referring to non-limiting example of FIG. 4, the pressure spikes with the denoted circles at the top of the peaks of the pressure spikes (i.e., pressure spikes 410a) are “liquid” peaks, meaning they occur when the pipette tip is submerged in the liquid in the container. Pressure peaks without the circles at the top of the peaks of the pressure spikes (i.e., pressure spikes 445a or 445b) are “partially sealed septum” peaks (which, in some cases, might be “wet septum” peaks, or the like). Liquid level is detected as denoted by dashed line 420 (hereinafter also referred to as “LLD”), which represents the time when the pipette tip enters the liquid in the container. As shown in FIG. 4, the partially sealed septum peaks occur both before (as pressure spikes 445a) and after (as pressure spikes 445b) the LLD line 420 (i.e., before and after the pipette tip has entered the liquid in the container).

As described above, because the partially sealed septum peaks 445a or 445b have a regular repetition pattern, there needs to be some way to distinguish them from the liquid peaks 410a. The algorithm described above with respect to FIG. 3D uses the slope of the rising edge of the pressure spike to distinguish between partially sealed septum peaks (i.e., with slope denoted by dot-dash line 360 in FIG. 3D) and liquid peaks (i.e., with slope denoted by dot-dash line 355 in FIG. 3D). The data for FIG. 3D was collected with hardware using brushed motors for both the Z-axis motor and the plunger motor, resulting in the pressure profiles being smooth as shown in FIG. 3D. The data for FIG. 4 was collected with hardware using stepper motors for both the Z-axis motor and the plunger motor. The individual steps of these motors are visible in the pressure traces. The difference in the two stepper motors, the transmission systems, and/or the like, result in the steps of the Z-axis motor being more pronounced in the pressure trace compared with the steps of the plunger motor. Because the partially sealed septum peaks 445a or 445b are influenced by the Z-axis motion, they have a noticeably jagged upslope, while the liquid peaks 410a that are not influenced by the Z-axis motion have a smoother upslope. Correct identification of liquid peaks and/or rejection of partially sealed septum peaks may thus be achieved by the differences in the peaks (i.e., by the smoothness or jaggedness of the peaks). Although the partially sealed septum peaks 445a or 445b that are influenced by the Z-axis motion are depicted as having a noticeably jagged upslope, while the liquid peaks 410a that are not influenced by the Z-axis motion are depicted as having a smoother upslope, the various embodiments are not so limited, and the configurations of the Z-axis motor and the plunger motor may be switched so that the partially sealed septum peaks 445a or 445b have a smoother upslope while the liquid peaks 410a have a noticeably jagged upslope.

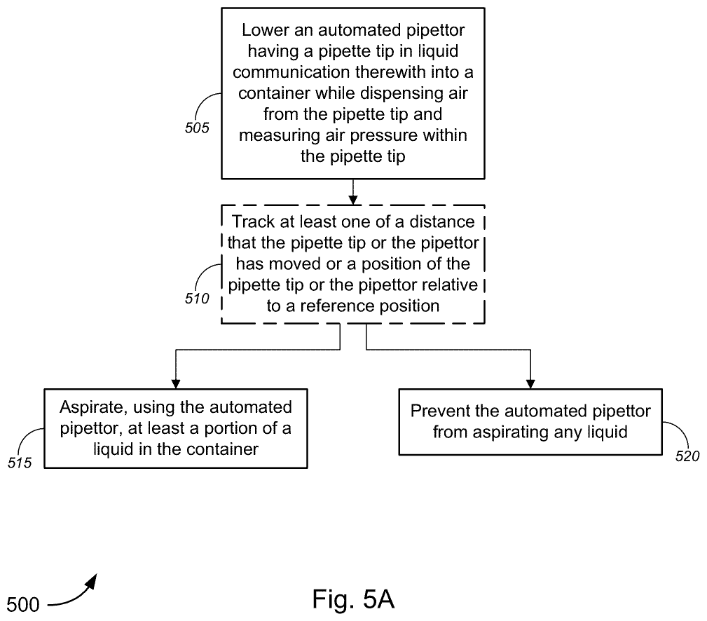

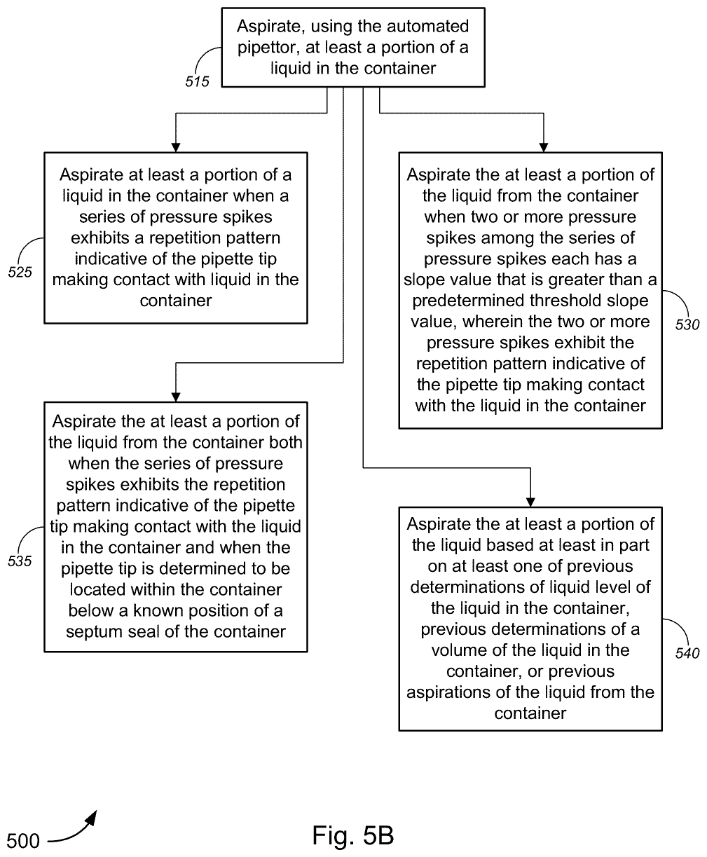

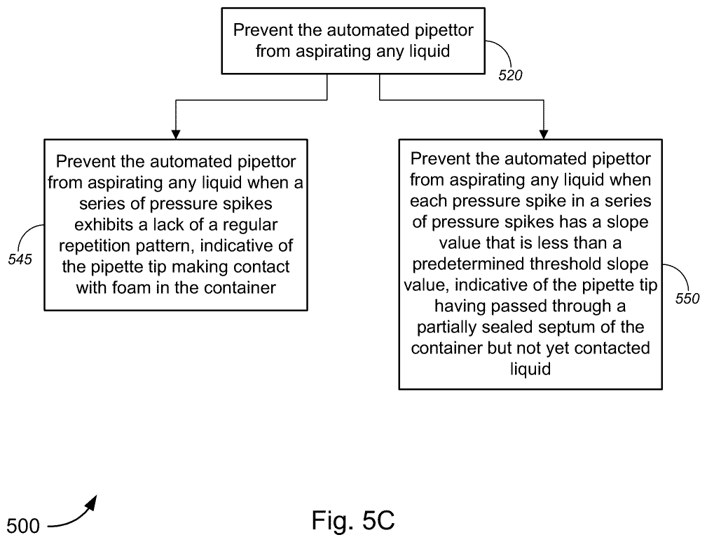

FIGS. 5A-5C (collectively, “FIG. 5”) are flow diagrams illustrating a method 500 for implementing pressure-based liquid level detection, in accordance with various embodiments.

While the techniques and procedures are depicted and/or described in a certain order for purposes of illustration, it should be appreciated that certain procedures may be reordered and/or omitted within the scope of various embodiments. Moreover, while the method 500 illustrated by FIG. 5 can be implemented by or with (and, in some cases, are described below with respect to) the systems, examples, or embodiments 100 and 200 of FIGS. 1 and 2A-2D, respectively (or components thereof), such methods may also be implemented using any suitable hardware (or software) implementation. Similarly, while each of the systems, examples, or embodiments 100 and 200 of FIGS. 1 and 2A-2D, respectively (or components thereof), can operate according to the method 500 illustrated by FIG. 5 (for example, by executing instructions embodied on a computer readable medium), the systems, examples, or embodiments 100 and 200 of FIGS. 1 and 2A-2D can each also operate according to other modes of operation and/or perform other suitable procedures.

In the non-limiting embodiment of FIG. 5A, method 500 might comprise, at block 505, lowering an automated pipettor having a pipette tip in liquid communication therewith into a container while dispensing air from the pipette tip and measuring air pressure within the pipette tip. According to some embodiments, the automated pipettor might be disposed within a work environment. At optional block 510, method 500 might comprise tracking at least one of a distance that the pipette tip or the pipettor has moved or a position of the pipette tip or the pipettor relative to a reference position. Method 500 might further comprise, based on a set of predetermined conditions, one of the following: aspirating, using the automated pipettor, at least a portion of a liquid in the container (at block 515); or preventing the automated pipettor from aspirating any liquid (at block 520).

With reference to the non-limiting embodiment of FIG. 5B, aspirating, using the automated pipettor, at least a portion of a liquid in the container (at block 515) might comprise at least one of: aspirating at least a portion of a liquid in the container when a series of pressure spikes exhibits a repetition pattern indicative of the pipette tip making contact with liquid in the container (block 525); aspirating the at least a portion of the liquid from the container when two or more pressure spikes among the series of pressure spikes each has a slope value that is greater than a predetermined threshold slope value, wherein the two or more pressure spikes exhibit the repetition pattern indicative of the pipette tip making contact with the liquid in the container (block 530); aspirating the at least a portion of the liquid from the container both when the series of pressure spikes exhibits the repetition pattern indicative of the pipette tip making contact with the liquid in the container and when the pipette tip is determined to be located within the container below a known position of a septum seal of the container (block 535); or aspirating the at least a portion of the liquid based at least in part on at least one of previous determinations of liquid level of the liquid in the container, previous determinations of a volume of the liquid in the container, or previous aspirations of the liquid from the container (block 540); and/or the like.

In some embodiments, the repetition pattern indicative of the pipette tip making contact with the liquid in the container might include, without limitation, at least one of a regular period or a regular frequency among two or more pressure spikes in the series of pressure spikes. Alternatively, or additionally, the repetition pattern might include, but is not limited to, at least four pressure spikes having periods between adjacent pressure spikes that are identical to each other to within a predetermined threshold error value. In some cases, the pipette tip may be determined to be located within the container below a known position of a septum seal of the container based on at least one of a distance that the pipette tip or the pipettor has moved or a position of the pipette tip or the pipettor relative to a reference position, or the like.

Turning to the non-limiting embodiment of FIG. 5C, preventing the automated pipettor from aspirating any liquid (at block 520) might comprise at least one of: preventing the automated pipettor from aspirating any liquid when a series of pressure spikes exhibits a lack of a regular repetition pattern, indicative of the pipette tip making contact with foam in the container (block 545); or preventing the automated pipettor from aspirating any liquid when each pressure spike in a series of pressure spikes has a slope value that is less than a predetermined threshold slope value, indicative of the pipette tip having passed through a partially sealed septum of the container but not yet contacted liquid (block 550); and/or the like.

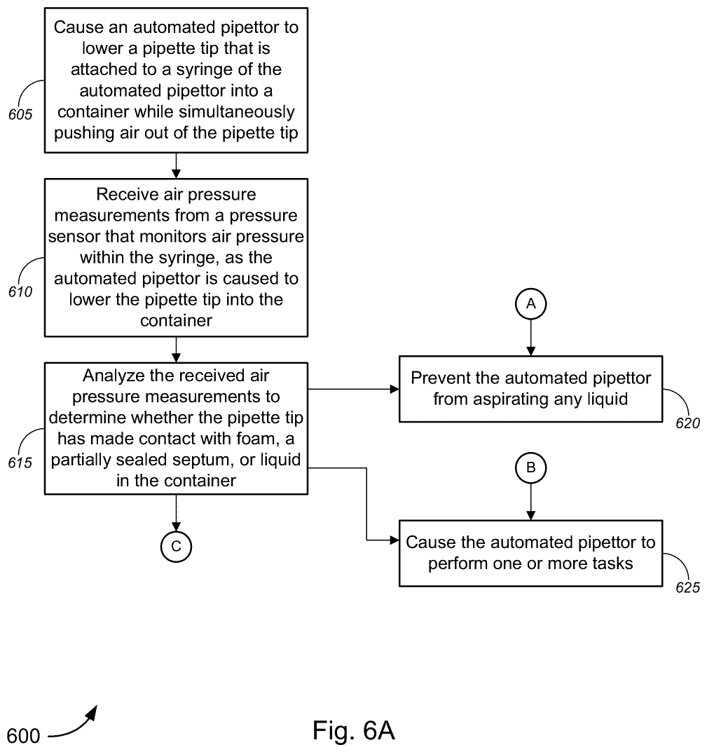

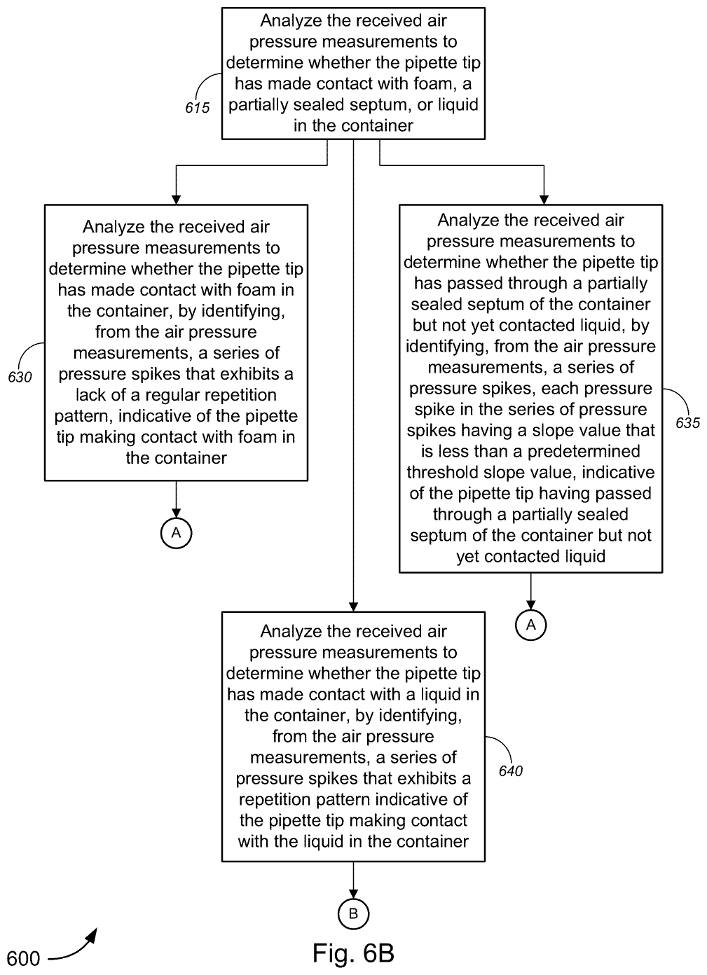

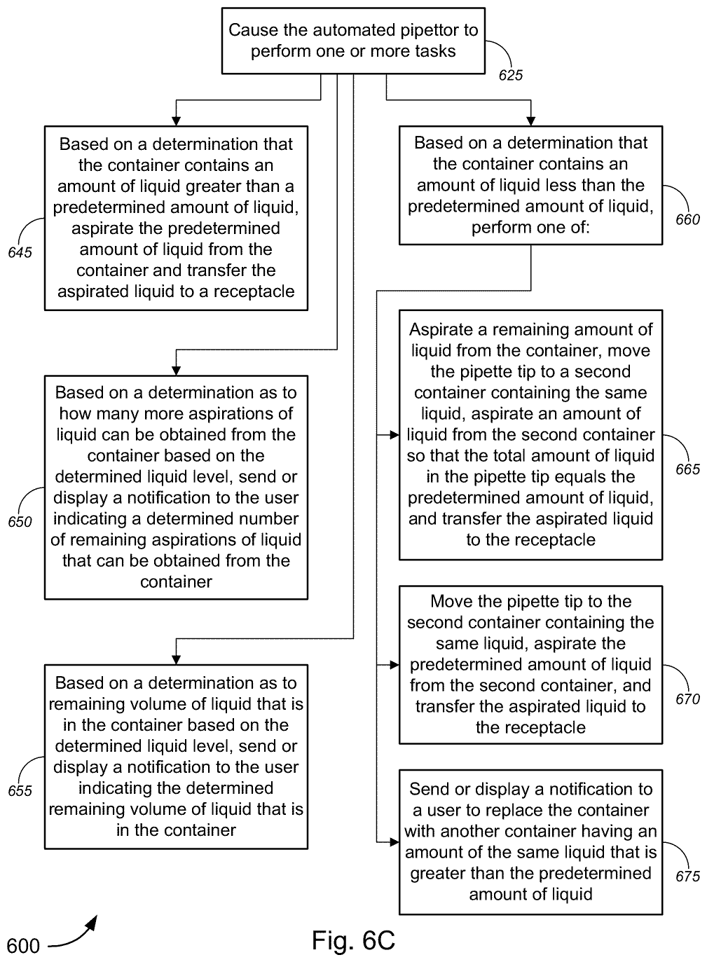

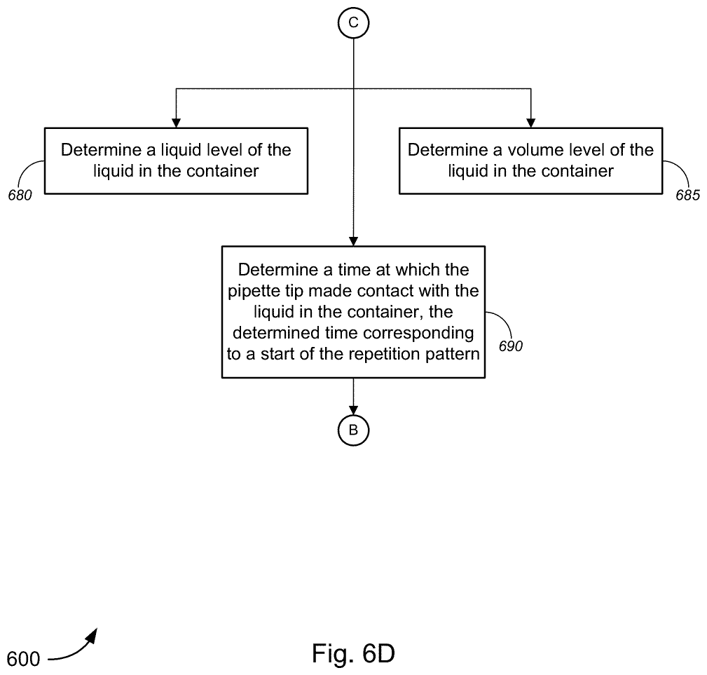

FIGS. 6A-6D (collectively, “FIG. 6”) are flow diagrams illustrating a method 600 for implementing pressure-based liquid level detection, in accordance with various embodiments. Method 600 of FIG. 6B returns to FIG. 6A following the circular marker denoted, “A,” or following the circular marker denoted, “B.” Method 600 of FIG. 6A might continue onto FIG. 6D following the circular marker denoted, “C.”

While the techniques and procedures are depicted and/or described in a certain order for purposes of illustration, it should be appreciated that certain procedures may be reordered and/or omitted within the scope of various embodiments. Moreover, while the method 600 illustrated by FIG. 6 can be implemented by or with (and, in some cases, are described below with respect to) the systems, examples, or embodiments 100 and 200 of FIGS. 1 and 2A-2D, respectively (or components thereof), such methods may also be implemented using any suitable hardware (or software) implementation. Similarly, while each of the systems, examples, or embodiments 100 and 200 of FIGS. 1 and 2A-2D, respectively (or components thereof), can operate according to the method 600 illustrated by FIG. 6 (for example, by executing instructions embodied on a computer readable medium), the systems, examples, or embodiments 100 and 200 of FIGS. 1 and 2A-2D can each also operate according to other modes of operation and/or perform other suitable procedures.

In the non-limiting embodiment of FIG. 6A, method 600 might comprise, at block 605, causing an automated pipettor to lower a pipette tip that is attached to a syringe of the automated pipettor into a container while simultaneously pushing air out of the pipette tip. Method 600 might further comprise, at block 610, receiving air pressure measurements from a pressure sensor that monitors air pressure within the syringe, as the automated pipettor is caused to lower the pipette tip into the container. At block 615, method 600 might comprise analyzing the received air pressure measurements to determine whether the pipette tip has made contact with foam, a partially sealed septum, or liquid in the container. Method 600 might further comprise, based on a set of predetermined conditions, one of the following: preventing the automated pipettor from aspirating any liquid (at block 620); or causing the automated pipettor to perform one or more tasks (at block 625). Method 600 might continue onto the process at block 680, 685, and/or 690 in FIG. 6D following the circular marker denoted, “C.”

With reference to the non-limiting embodiment of FIG. 6B, analyzing the received air pressure measurements to determine whether the pipette tip has made contact with foam, a partially sealed septum, or liquid in the container (at block 615) might comprise one of: analyzing the received air pressure measurements to determine whether the pipette tip has made contact with foam in the container, by identifying, from the air pressure measurements, a series of pressure spikes that exhibits a lack of a regular repetition pattern, indicative of the pipette tip making contact with foam in the container [also referred to as “foam condition”] (block 630); analyzing the received air pressure measurements to determine whether the pipette tip has passed through a partially sealed septum of the container but not yet contacted liquid, by identifying, from the air pressure measurements, a series of pressure spikes, each pressure spike in the series of pressure spikes having a slope value that is less than a predetermined threshold slope value, indicative of the pipette tip having passed through a partially sealed septum of the container but not yet contacted liquid [also referred to as “partially sealed septum condition”] (block 635); analyzing the received air pressure measurements to determine whether the pipette tip has made contact with a liquid in the container, by identifying, from the air pressure measurements, a series of pressure spikes that exhibits a repetition pattern indicative of the pipette tip making contact with the liquid in the container [also referred to as “liquid contact condition”] (block 640). In response to either identifying the series of pressure spikes at block 630 (i.e., the “foam condition”) or identifying the series of pressure spikes at block 635 (i.e., the “partially sealed septum condition”), method 600 might return to FIG. 6A following the circular marker denoted, “A,” leading to prevention of the automated pipettor from aspirating any liquid (at block 620). Alternatively, in response to identifying the series of pressure spikes at block 640 (i.e., the “liquid contact condition”), method 600 might return to FIG. 6A following the circular marker denoted, “B,” leading to causing the automated pipettor to perform one or more tasks (at block 625).

Turning to the non-limiting embodiment of FIG. 6C, causing the automated pipettor to perform one or more tasks (at block 625) might comprise, based on a determination that the container contains an amount of liquid greater than a predetermined amount of liquid, aspirating the predetermined amount of liquid from the container and transferring the aspirated liquid to a receptacle (block 645). Alternatively, or additionally, causing the automated pipettor to perform one or more tasks (at block 625) might comprise, based on a determination as to how many more aspirations of liquid can be obtained from the container based on the determined liquid level, sending or displaying a notification to the user indicating a determined number of remaining aspirations of liquid that can be obtained from the container (block 650). Alternatively, or additionally, causing the automated pipettor to perform one or more tasks (at block 625) might comprise, based on a determination as to remaining volume of liquid that is in the container based on the determined liquid level, sending or displaying a notification to the user indicating the determined remaining volume of liquid that is in the container (block 655).

Alternatively, or additionally, causing the automated pipettor to perform one or more tasks (at block 625) might comprise, at block 660, based on a determination that the container contains an amount of liquid less than the predetermined amount of liquid, performing one of: aspirating a remaining amount of liquid from the container, moving the pipette tip to a second container containing the same liquid, aspirating an amount of liquid from the second container so that the total amount of liquid in the pipette tip equals the predetermined amount of liquid, and transferring the aspirated liquid to the receptacle (block 665); moving the pipette tip to the second container containing the same liquid, aspirating the predetermined amount of liquid from the second container, and transferring the aspirated liquid to the receptacle (block 670); or sending or displaying a notification to a user to replace the container with another container having an amount of the same liquid that is greater than the predetermined amount of liquid (block 675). In some cases, the receptacle might comprise one of a microscope slide or a third container, and/or the like.

At block 680 in FIG. 6D (following the circular marker denoted, “C,” in FIG. 6A), method 600 might comprise determining a liquid level of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, at block 685 in FIG. 6D (following the circular marker denoted, “C,” in FIG. 6A), method 600 might comprise determining a volume of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, at block 690 in FIG. 6D (following the circular marker denoted, “C,” in FIG. 6A), method 600 might comprise determining a time at which the pipette tip made contact with the liquid in the container, the determined time corresponding to a start of the repetition pattern. In such cases, method 600 might return to the process at block 625 following the circular marker denoted, “B,” leading to causing the automated pipettor to perform one or more tasks based on the determined time at which the pipette tip made contact with the liquid in the container.

### Exemplary Computer System and Hardware Implementation

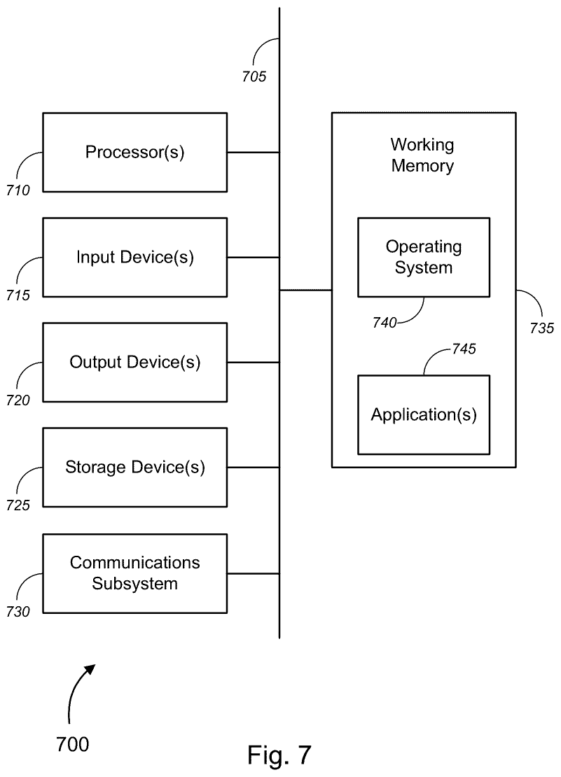

FIG. 7 is a block diagram illustrating an exemplary computer or system hardware architecture, in accordance with various embodiments. FIG. 7 provides a schematic illustration of one embodiment of a computer system 700 of the service provider system hardware that can perform the methods provided by various other embodiments, as described herein, and/or can perform the functions of computer or hardware system (i.e., computing systems 105a and 105b, automated pipettor 115 and 205, and user device(s) 125, etc.), as described above. It should be noted that FIG. 7 is meant only to provide a generalized illustration of various components, of which one or more (or none) of each may be utilized as appropriate. FIG. 7, therefore, broadly illustrates how individual system elements may be implemented in a relatively separated or relatively more integrated manner.

The computer or hardware system 700—which might represent an embodiment of the computer or hardware system (i.e., computing systems 105a and 105b, automated pipettor 115 and 205, and user device(s) 125, etc.), described above with respect to FIGS. 1-6—is shown comprising hardware elements that can be electrically coupled via a bus 705 (or may otherwise be in communication, as appropriate). The hardware elements may include one or more processors 710, including, without limitation, one or more general-purpose processors and/or one or more special-purpose processors (such as microprocessors, digital signal processing chips, graphics acceleration processors, and/or the like); one or more input devices 715, which can include, without limitation, a mouse, a keyboard, and/or the like; and one or more output devices 720, which can include, without limitation, a display device, a printer, and/or the like.

The computer or hardware system 700 may further include (and/or be in communication with) one or more storage devices 725, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 700 might also include a communications subsystem 730, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 730 may permit data to be exchanged with a network (such as the network described below, to name one example), with other computer or hardware systems, and/or with any other devices described herein. In many embodiments, the computer or hardware system 700 will further comprise a working memory 735, which can include a RAM or ROM device, as described above.

The computer or hardware system 700 also may comprise software elements, shown as being currently located within the working memory 735, including an operating system 740, device drivers, executable libraries, and/or other code, such as one or more application programs 745, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 700 and/or might take the form of source and/or installable code, which, upon compilation and/or installation on the computer or hardware system 700 (for example, using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 700) to perform methods in accordance with various embodiments of the invention. According to a set of embodiments, some or all of the procedures of such methods are performed by the computer or hardware system 700 in response to processor 710 executing one or more sequences of one or more instructions (which might be incorporated into the operating system 740 and/or other code, such as an application program 745) contained in the working memory 735. Such instructions may be read into the working memory 735 from another computer readable medium, such as one or more of the storage device(s) 725. Merely by way of example, execution of the sequences of instructions contained in the working memory 735 might cause the processor(s) 710 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 700, various computer readable media might be involved in providing instructions/code to processor(s) 710 for execution and/or might be used to store and/or carry such instructions/code (for example, as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 725. Volatile media includes, without limitation, dynamic memory, such as the working memory 735. In some alternative embodiments, a computer readable medium may take the form of transmission media, which includes, without limitation, coaxial cables, copper wire, and fiber optics, including the wires that comprise the bus 705, as well as the various components of the communication subsystem 730 (and/or the media by which the communications subsystem 730 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 700. These signals, which might be in the form of electromagnetic signals, acoustic signals, optical signals, and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a storage device 725 either before or after execution by the processor(s) 710.

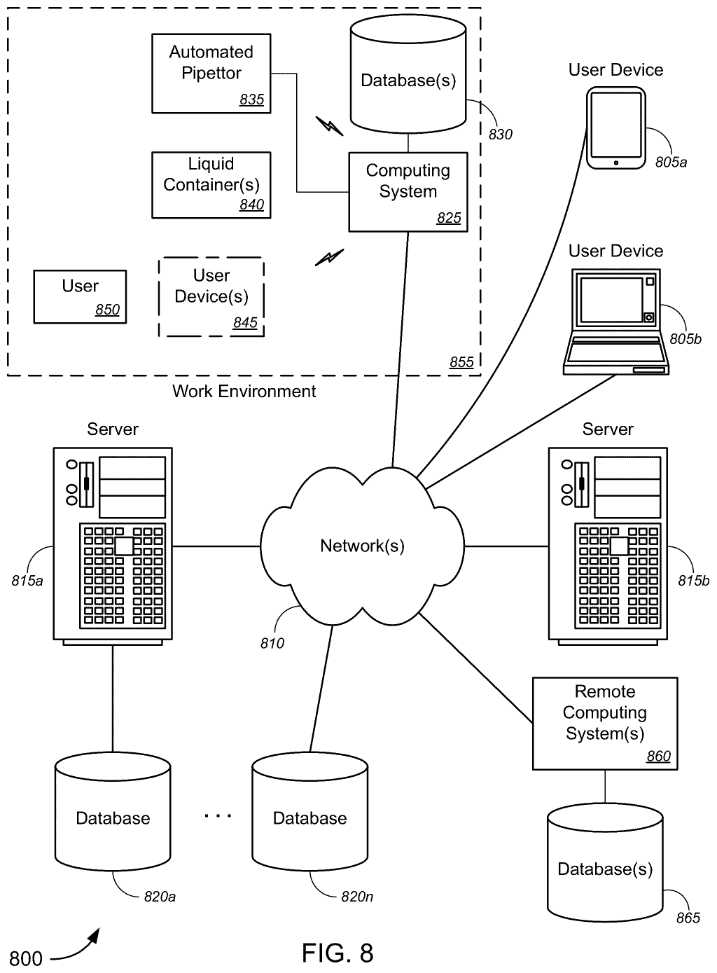

As noted above, a set of embodiments comprises methods and systems for implementing liquid level detection, particularly, to methods, systems, and apparatuses for implementing pressure-based liquid level detection, and, more particularly, to methods, systems, and apparatuses for implementing pressure-based liquid level detection that takes into account presence of foam, wet septum seals on a container, and/or pressure changes caused by a partially sealed septum of a container. FIG. 8 illustrates a schematic diagram of a system 800 that can be used in accordance with one set of embodiments. The system 800 can include one or more user computers, user devices, or customer devices 805. A user computer, user device, or customer device 805 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 805 can also have any of a variety of applications, including one or more applications configured to perform methods provided by various embodiments (as described above, for example), as well as one or more office applications, database client and/or server applications, and/or web browser applications. Alternatively, a user computer, user device, or customer device 805 can be any other electronic device, such as a thin-client computer, Internet-enabled mobile telephone, and/or personal digital assistant, capable of communicating via a network (for example, the network(s) 810 described below) and/or of displaying and navigating web pages or other types of electronic documents. Although the exemplary system 800 is shown with two user computers, user devices, or customer devices 805, any number of user computers, user devices, or customer devices can be supported.

Certain embodiments operate in a networked environment, which can include a network(s) 810. The network(s) 810 can be any type of network familiar to those skilled in the art that can support data communications using any of a variety of commercially-available (and/or free or proprietary) protocols, including, without limitation, TCP/IP, SNA™, IPX™ AppleTalk™, and the like. Merely by way of example, the network(s) 810 (similar to network(s) 140 of FIG. 1, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (for example, an Internet service provider (“ISP”)). In another embodiment, the network might include a core network of the service provider, and/or the Internet.

Embodiments can also include one or more server computers 815. Each of the server computers 815 may be configured with an operating system, including, without limitation, any of those discussed above, as well as any commercially (or freely) available server operating systems. Each of the servers 815 may also be running one or more applications, which can be configured to provide services to one or more clients 805 and/or other servers 815.

Merely by way of example, one of the servers 815 might be a data server, a web server, a cloud computing device(s), or the like, as described above. The data server might include (or be in communication with) a web server, which can be used, merely by way of example, to process requests for web pages or other electronic documents from user computers 805. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 805 to perform methods of the invention.

The server computers 815, in some embodiments, might include one or more application servers, which can be configured with one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™ IBM™, and the like, which can process requests from clients (including, depending on the configuration, dedicated database clients, API clients, web browsers, etc.) running on a user computer, user device, or customer device 805 and/or another server 815. In some embodiments, an application server can perform one or more of the processes for implementing liquid level detection, particularly, to methods, systems, and apparatuses for implementing pressure-based liquid level detection, and, more particularly, to methods, systems, and apparatuses for implementing pressure-based liquid level detection that takes into account presence of foam, wet septum seals on a container, and/or pressure changes caused by a partially sealed septum of a container, as described in detail above. Data provided by an application server may be formatted as one or more web pages (comprising HTML, JavaScript, etc., for example) and/or may be forwarded to a user computer 805 via a web server (as described above, for example). Similarly, a web server might receive web page requests and/or input data from a user computer 805 and/or forward the web page requests and/or input data to an application server. In some cases, a web server may be integrated with an application server.

In accordance with further embodiments, one or more servers 815 can function as a file server and/or can include one or more of the files (for example, application code, data files, etc.) necessary to implement various disclosed methods, incorporated by an application running on a user computer 805 and/or another server 815. Alternatively, as those skilled in the art will appreciate, a file server can include all necessary files, allowing such an application to be invoked remotely by a user computer, user device, or customer device 805 and/or server 815.

It should be noted that the functions described with respect to various servers herein (for example, application server, database server, web server, file server, etc.) can be performed by a single server and/or a plurality of specialized servers, depending on implementation-specific needs and parameters.

In certain embodiments, the system can include one or more databases 820a-820n (collectively, “databases 820”). The location of each of the databases 820 is discretionary: merely by way of example, a database 820a might reside on a storage medium local to (and/or resident in) a server 815a (and/or a user computer, user device, or customer device 805). Alternatively, a database 820n can be remote from any or all of the computers 805, 815, so long as it can be in communication (for example, via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 820 can be a relational database, such as an Oracle database, that is adapted to store, update, and retrieve data in response to SQL-formatted commands. The database might be controlled and/or maintained by a database server, as described above, for example.

According to some embodiments, system 800 might further comprise computing system 825 and corresponding database(s) 830 (similar to computing system 105a and corresponding database(s) 110a of FIG. 1, or the like), automated pipette or pipettor 835 (similar to automated pipettor 115 and 205 of FIGS. 1 and 2, or the like) that may be used to automatically pipette liquids in one or more containers 840 (similar to container(s) 120 and 270a-270d of FIGS. 1 and 2, or the like). In some cases, the automated pipettor 835 may be controlled by the computing system 825 and/or may be controlled by user device(s) 845 (optional; similar to user device(s) 125 of FIG. 1, or the like) that is associated with or otherwise used by user 850 (similar to user 130 of FIG. 1, or the like). In some instances, the computing system 825, the database(s) 830, the automated pipettor 835, the container(s) 840, the user device(s) 845, and the user 850 may be disposed or located at a work environment 855, which might include, but is not limited to, a laboratory, or the like. In some embodiments, system 800 might further comprise remote computing system(s) 860 and corresponding database(s) 865 that is accessible via network(s) 810 to remotely control, or to otherwise remotely communicate with, automated pipettor 835.

In operation, computing system 825, user device(s) 805 or 845, and/or remote computing system 860 (collectively, “computing system” or the like) might cause automated pipettor 835 to lower a pipette tip that is attached (whether removably or permanently attached) to a syringe of the automated pipettor 835 into a container (for example, container 840 among the one or more containers 840, or the like) while simultaneously causing a plunger of the syringe to push air out of the pipette tip. In some cases, for removably affixed pipette tips, one of the pipette tips might be used to aspirate at least a portion of the liquid from one container among the containers 840, and then may be subsequently disposed of using the pipette tip dispenser or exchanger or the like, with a new (and unused) pipette tip among the pipette tips being affixed to the syringe in preparation for aspirating liquid from a different container 840. By using different pipette tips with different liquids or with different containers (regardless of whether the same liquid is in multiple containers that are used), cross-contamination may be limited or avoided, and, with the use of clean or new pipette tips, “clean” pressure measurements can be assured (assuming no liquid ever aspirates or enters the syringe, and rather remains only in the pipette tips), thereby allowing for more accurate and precise pressure-based liquid level detection. Some automated pipettors, however, are designed with fixed or permanent pipette tips, in which case, cleaning cycles (during which the pipette tip is cleaned using predetermined cleaning protocols or the like) may be implemented between aspirations to ensure “clean” pressure measurements for successive operations.

The automated pipettor 835, for example by using the computing system, might receive air pressure measurements (whether continuously, periodically, randomly, or in response to commands for pressure measurements, or the like) from a pressure sensor that monitors air pressure within the syringe, as the automated pipettor 835 is caused to lower the pipette tip into the container (for example, container 840, or the like). The automated pipettor, for example by using the computing system, might analyze the received air pressure measurements to determine whether the pipette tip has made contact with a liquid in the container, in some cases, by identifying, from the air pressure measurements, pressure measurements or a series of pressure spikes that exhibits a repetition pattern indicative of the pipette tip making contact with the liquid in the container (such as depicted, for example, by pressure measurements or series of pressure spikes 310 in FIG. 3B, or the like, which corresponds to the pipette tip 260 making contact with the liquid 280 in container 270b as depicted in FIG. 2B, or the like). In some embodiments, the pressure measurements or series of pressure spikes that exhibit a repetition pattern might comprise a plurality of (for example, at least four) consecutive pressure peaks (in some cases, at least five consecutive pressure peaks) having at least one of a regular period or a regular frequency. In some cases, the repetition pattern might comprise the plurality of consecutive pressure peaks having periods between adjacent pressure peaks that are substantially identical to each other or that are identical to each other to within a predetermined threshold error value (which might include, but is not limited to, one of about 10 ms, about 20 ms, about 30 ms, about 40 ms, about 50 ms, about 60 ms, about 70 ms, about 80 ms, about 90 ms, about 100 ms, about 125 ms, about 150 ms, about 175 ms, about 200 ms, about 225 ms, about 250 ms, about 275 ms, about 300 ms, about 325 ms, about 350 ms, about 375 ms, about 400 ms, about 425 ms, about 450 ms, about 475 ms, about 500 ms, or the like, or a threshold error value in a range between about 1 ms and about 500 ms). In response to identifying such a series of pressure spikes, the computing system might cause the automated pipettor 835 to perform one or more tasks.

Merely by way of example, in some cases, performing the one or more tasks might comprise, based on a determination that the container contains an amount of liquid greater than a predetermined amount of liquid, aspirating the predetermined amount of liquid from the container and transferring the aspirated liquid to a receptacle (which might include, but is not limited to, one of a microscope slide or another container, or the like). Alternatively, or additionally, performing the one or more tasks might comprise, based on a determination that the container contains an amount of liquid less than the predetermined amount of liquid, performing one of: aspirating a remaining amount of liquid from the container, moving the pipette tip to a second container containing the same liquid, aspirating an amount of liquid from the second container so that the total amount of liquid in the pipette tip equals the predetermined amount of liquid, and transferring the aspirated liquid to the receptacle; moving the pipette tip to the second container containing the same liquid, aspirating the predetermined amount of liquid from the second container, and transferring the aspirated liquid to the receptacle; or sending or displaying a notification to a user (for example, user 850, or the like, via user device(s) 845, or the like) to replace the container with another container having an amount of the same liquid that is greater than the predetermined amount of liquid. Alternatively, or additionally, performing the one or more tasks might comprise, based on a determination as to how many more aspirations of liquid can be obtained from the container based on the determined liquid level, sending or displaying a notification to the user (for example, user 850, or the like, via user device(s) 845, or the like) indicating a determined number of remaining aspirations of liquid that can be obtained from the container. Alternatively, or additionally, performing the one or more tasks might comprise, based on a determination as to remaining volume of liquid that is in the container based on the determined liquid level, sending or displaying a notification to the user (for example, user 850, or the like, via user device(s) 845, or the like) indicating the determined remaining volume of liquid that is in the container.

In some embodiments, the automated pipettor, for example by using the computing system, might track at least one of a distance that the pipette tip or the pipettor has moved or a position of the pipette tip or the pipettor relative to a reference position, and/or the like. According to some embodiments, the computing system might cause the automated pipettor 835 (and/or the automated pipettor 835 might be configured) to aspirate at least a portion of the liquid from the container when two or more pressure spikes among the series of pressure spikes each has a slope value that is greater than a predetermined threshold slope value, wherein the two or more pressure spikes exhibit the repetition pattern indicative of the pipette tip making contact with the liquid in the container. Alternatively, or additionally, the computing system might cause the automated pipettor 835 (and/or the automated pipettor 835 might be configured) to aspirate the at least a portion of the liquid from the container both when the series of pressure spikes exhibits the repetition pattern indicative of the pipette tip making contact with the liquid in the container and when the pipette tip is determined to be located within the container below a known position of a septum seal of the container. In some cases, the pipette tip might be determined to be located within the container below a known position of a septum seal of the container based on at least one of a distance that the pipette tip or the pipettor has moved or a position of the pipette tip or the pipettor relative to a reference position. Alternatively, or additionally, the computing system might cause the automated pipettor 835 (and/or the automated pipettor 835 might be configured) to aspirate the at least a portion of the liquid based at least in part on at least one of previous determinations of liquid level of the liquid in the container, previous determinations of a volume of the liquid in the container, or previous aspirations of the liquid from the container, and/or the like.

According to some embodiments, the automated pipettor 835 might be configured, using a first type of actuation, to push air through the pipette tip and might be configured, using a second type of actuation different from the first type of actuation, to move a syringe and the pipette tip that is affixed to the syringe downward toward the container. The apparatus might further be configured to distinguish pressure spikes corresponding to the first type of actuation from pressure spikes corresponding to the second type of actuation and to aspirate the liquid from the container when a series of pressure spikes caused by the first type of actuation exhibits the repetition pattern indicative of the pipette tip making contact with the liquid in the container. In some instances, the automated pipettor might further comprise a plunger motor and a Z-axis motor, wherein the plunger motor causes the first type of actuation, while the Z-axis motor causes the second type of actuation, wherein the first type of actuation and the second type of actuation are distinguishable from each other based on one of the following: the plunger motor comprises a servo motor, while the Z-axis motor comprises a stepper motor; the plunger motor comprises a stepper motor, while the Z-axis motor comprises a servo motor; the plunger motor and the Z-axis motor are both stepper motors, wherein a first pressure curve resultant from at least one of characteristics of the pipette tip or characteristics of the Z-axis motor that influence how the pipette tip moves is different from a second pressure curve resultant from at least one of characteristics of the plunger or characteristics of the plunger motor that influence how the plunger moves; or the plunger motor and the Z-axis motor are both servo motors, wherein a third pressure curve resultant from at least one of characteristics of the pipette tip or characteristics of the Z-axis motor that influence how the pipette tip moves is different from a fourth pressure curve resultant from at least one of characteristics of the plunger or characteristics of the plunger motor that influence how the plunger moves; wherein the characteristics of the pipette tip comprise an outer diameter of the pipette tip, wherein the characteristics of the Z-axis motor comprise at least one of type of motor, control of motor, or transmission between the motor and the pipette tip, and/or the like, wherein the characteristics of the plunger comprise a diameter of the plunger, wherein the characteristics of the plunger motor comprise at least one of type of motor, control of motor, or transmission between the motor and the plunger, and/or the like.

In some embodiments, the automated pipettor, for example by using the computing system, might determine a liquid level of the liquid in the container based on the determined repetition pattern exhibited by the pressure spikes as the pipette tip is moved within the container and based on an indication that the pipette tip has made contact with the liquid in the container.

In some embodiments, determining the liquid level of the liquid in the container might comprise determining a liquid level of the liquid in the container based at least in part on one or more of geometry of the container, height of the container, a distance between a reference point on the container and a reference point on the automated pipettor, height of the pipette tip relative to the reference point on the container, position of the pipette tip as the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, determining the liquid level of the liquid in the container might comprise determining a volume of the liquid in the container based at least in part on one or more of geometry of the container, height of the container, a distance between a reference point on the container and a reference point on the automated pipettor, height of the pipette tip relative to the reference point on the container, position of the pipette tip as the pipette tip has passed through a top seal of the container, position of the pipette tip corresponding to a start of the repetition pattern, or position of the pipette tip corresponding to the leading pressure valley preceding the repetition pattern relative to a known position of the top seal of the container, and/or the like.

Alternatively, or additionally, determining the liquid level of the liquid in the container might comprise determining a time at which the pipette tip made contact with the surface of the liquid in the container, the determined time corresponding to a start of the repetition pattern. In such cases, causing the automated pipettor to perform one or more tasks might comprise causing the automated pipettor to perform one or more tasks based on the determined time at which the pipette tip made contact with the surface of the liquid in the container.

According to some embodiments, the automated pipettor, for example by using the computing system, might analyze the received air pressure measurements to determine whether the pipette tip has made contact with foam that has accumulated above the surface of the liquid in the container, in some cases, by identifying, from the air pressure measurements, pressure measurements or a series of pressure spikes that is indicative of the pipette tip making contact with foam that has accumulated above the surface of the liquid in the container (such as depicted, for example, by pressure measurements or series of pressure spikes 325 in FIG. 3C, or the like, which corresponds to the pipette tip 260 making contact with foam 285 that has accumulated above the surface 280a of the liquid 280 in container 270b as depicted in FIG. 2C, or the like), said pressure measurements or series of pressure spikes comprising pressure peaks having periods between adjacent pressure peaks that are different from each other. In response to identifying said pressure measurements or series of pressure spikes, the automated pipettor, for example by using the computing system, might dismiss said pressure measurements or series of pressure spikes in determining the liquid level of the liquid in the container. In some embodiments, the computing system might prevent the automated pipettor 835 (and/or the automated pipettor 835 might be configured to prevent) from aspirating any liquid when a series of pressure spikes exhibits a lack of a regular repetition pattern, indicative of the pipette tip making contact with foam in the container.

Alternatively, or additionally, the automated pipettor, for example by using the computing system, might analyze the received air pressure measurements to determine whether the pipette tip has passed through a partially sealed septum of the container but not yet contacted liquid (i.e., has moved into an air-filled region between the wet septum seal and the surface of the liquid in the container), in some cases, by identifying, from the air pressure measurements, pressure measurements or a series of pressure spikes, each pressure spike in the series of pressure spikes having a slope value that is less than a predetermined threshold slope value, indicative of the pipette tip having passed through a partially sealed septum of the container but not yet contacted liquid (such as depicted, for example, by pressure measurements or series of pressure spikes 345 in FIG. 3D, or the like, which corresponds to the pipette tip 260 moving past the wet top seal or septum seal 275 of FIG. 2D so that the pipette tip 260 is between the wet septum seal 275 and the surface 280a of the liquid 280 in liquid container 270c (as shown in FIG. 2E), or the like), said pressure profile comprising consecutive pressure peaks having periods between adjacent pressure peaks that are substantially identical to each other or that are identical to each other. In response to identifying said pressure measurements or series of pressure spikes, the automated pipettor, for example by using the computing system, might dismiss said pressure measurements or series of pressure spikes in determining the liquid level of the liquid in the container. According to some embodiments, the computing system might prevent the automated pipettor 835 (and/or the automated pipettor 835 might be configured to prevent) from aspirating any liquid when each pressure spike in a series of pressure spikes has a slope value that is less than a predetermined threshold slope value, indicative of the pipette tip having passed through a partially sealed septum of the container but not yet contacted liquid.

According to some embodiments, the computing system might cause the automated pipettor 835 (and/or the automated pipettor 835 might be configured) to move the pipette tip from a position above the container to a second position along an X-Y plane an X-Y plane that is parallel to a workspace surface on which the base is disposed, by sending third command instructions to an X-Y stage to cause the syringe to move to the second position along the X-Y plane. In this manner, the automated pipettor 835 may align the pipette tip directly above a container or may move the pipette tip from above one container to above another container, prior to lowering the pipette tip into the selected container.

These and other functions of the system 800 (and its components) are described in greater detail above with respect to FIGS. 1-6.

### Exemplary Embodiments

Embodiment 1. An apparatus, comprising: an automated pipettor having a pipette tip affixed thereto; and a pressure sensor in fluid communication with the pipette tip; wherein the apparatus is configured to aspirate at least a portion of the liquid from a container having a liquid contained therein when a series of pressure spikes exhibits a repetition pattern indicative of the pipette tip making contact with the liquid in the container.

Embodiment 2. The apparatus of embodiment 1, wherein the repetition pattern indicative of the pipette tip making contact with the liquid in the container comprises at least one of a regular period or a regular frequency among two or more pressure spikes in the series of pressure spikes.

Embodiment 3. The apparatus of embodiment 1 or 2, wherein the apparatus is further configured to track at least one of a distance that the pipette tip or the pipettor has moved or a position of the pipette tip or the pipettor relative to a reference position.

Embodiment 4. The apparatus of embodiments 1-3, wherein the apparatus is further configured to aspirate the at least a portion of the liquid from the container when two or more pressure spikes among the series of pressure spikes each has a slope value that is greater than a predetermined threshold slope value, wherein the two or more pressure spikes exhibit the repetition pattern indicative of the pipette tip making contact with the liquid in the container.

Embodiment 5. The apparatus of embodiments 1-4, wherein the apparatus is further configured to aspirate the at least a portion of the liquid from the container both when the series of pressure spikes exhibits the repetition pattern indicative of the pipette tip making contact with the liquid in the container and when the pipette tip is determined to be located within the container below a known position of a septum seal of the container.

Embodiment 6. The apparatus of embodiment 5, wherein the pipette tip is determined to be located within the container below a known position of a septum seal of the container based on at least one of a distance that the pipette tip or the pipettor has moved or a position of the pipette tip or the pipettor relative to a reference position.

Embodiment 7. The apparatus of embodiments 1-6, wherein the apparatus is further configured to aspirate the at least a portion of the liquid based at least in part on at least one of previous determinations of liquid level of the liquid in the container, previous determinations of a volume of the liquid in the container, or previous aspirations of the liquid from the container.

Embodiment 8. The apparatus of embodiments 1-7, wherein the automated pipettor is configured, using a first type of actuation, to push air through the pipette tip and configured, using a second type of actuation different from the first type of actuation, to move a syringe and the pipette tip that is affixed to the syringe downward toward the container, wherein the apparatus is further configured to distinguish pressure spikes corresponding to the first type of actuation from pressure spikes corresponding to the second type of actuation and to aspirate the liquid from the container when a series of pressure spikes caused by the first type of actuation exhibits the repetition pattern indicative of the pipette tip making contact with the liquid in the container.

Embodiment 9. The apparatus of embodiment 8, wherein the automated pipettor further comprises a plunger motor and a Z-axis motor, wherein the plunger motor causes the first type of actuation, while the Z-axis motor causes the second type of actuation, wherein the first type of actuation and the second type of actuation are distinguishable from each other based on one of the following: the plunger motor comprises a servo motor, while the Z-axis motor comprises a stepper motor; the plunger motor comprises a stepper motor, while the Z-axis motor comprises a servo motor; the plunger motor and the Z-axis motor are both stepper motors, wherein a first pressure curve resultant from at least one of characteristics of the pipette tip or characteristics of the Z-axis motor that influence how the pipette tip moves is different from a second pressure curve resultant from at least one of characteristics of the plunger or characteristics of the plunger motor that influence how the plunger moves; or the plunger motor and the Z-axis motor are both servo motors, wherein a third pressure curve resultant from at least one of characteristics of the pipette tip or characteristics of the Z-axis motor that influence how the pipette tip moves is different from a fourth pressure curve resultant from at least one of characteristics of the plunger or characteristics of the plunger motor that influence how the plunger moves; wherein the characteristics of the pipette tip comprise an outer diameter of the pipette tip, wherein the characteristics of the Z-axis motor comprise at least one of type of motor, control of motor, or transmission between the motor and the pipette tip, wherein the characteristics of the plunger comprise a diameter of the plunger, and wherein the characteristics of the plunger motor comprise at least one of type of motor, control of motor, or transmission between the motor and the plunger.

Embodiment 10. The apparatus of embodiments 1-9, wherein the repetition pattern comprises at least four pressure spikes having periods between adjacent pressure spikes that are identical to each other to within a first predetermined threshold error value.

Embodiment 11. The apparatus of embodiments 1-10, wherein the apparatus is further configured to: determine a liquid level of the liquid in the container based on the determined repetition pattern exhibited by the pressure spikes as the pipette tip is moved within the container and based on an indication that the pipette tip has made contact with the liquid in the container.

Embodiment 12. The apparatus of embodiment 11, wherein determining the liquid level of the liquid in the container comprises determining a liquid level of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to a leading pressure valley preceding the repetition pattern relative to a known position of the top seal of the container.

Embodiment 13. The apparatus of embodiment 11, wherein determining the liquid level of the liquid in the container comprises determining a volume of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to a leading pressure valley preceding the repetition pattern relative to a known position of the top seal of the container.

Embodiment 14. The apparatus of embodiment 11, wherein determining the liquid level of the liquid in the container comprises determining a time at which the pipette tip made contact with the surface of the liquid in the container, the determined time corresponding to a start of the repetition pattern.

Embodiment 15. The apparatus of embodiments 1-14, wherein the apparatus comprises at least one of a processor disposed in the automated pipettor, a computing system communicatively coupled to the automated pipettor and disposed in the work environment, a remote computing system disposed external to the work environment and accessible over a network, or a cloud computing system.

Embodiment 16. The apparatus of embodiments 1-15, wherein the apparatus is further configured to prevent the automated pipettor from aspirating any liquid when a series of pressure spikes exhibits a lack of a regular repetition pattern, indicative of the pipette tip making contact with foam in the container.

Embodiment 17. The apparatus of embodiments 1-16, wherein the apparatus is further configured to prevent the automated pipettor from aspirating any liquid when each pressure spike in a series of pressure spikes has a slope value that is less than a predetermined threshold slope value, indicative of the pipette tip having passed through a partially sealed septum of the container but not yet contacted liquid.

Embodiment 18. A method, comprising: lowering an automated pipettor having a pipette tip in liquid communication therewith into a container while dispensing air from the pipette tip and measuring air pressure within the pipette tip; and aspirating, using the automated pipettor, at least a portion of a liquid in the container when a series of pressure spikes exhibits a repetition pattern indicative of the pipette tip making contact with liquid in the container.

Embodiment 19. The method of embodiment 18, wherein the repetition pattern indicative of the pipette tip making contact with the liquid in the container comprises at least one of a regular period or a regular frequency among two or more pressure spikes in the series of pressure spikes.

Embodiment 20. The method of embodiment 18 or 19, wherein the repetition pattern comprises at least four pressure spikes having periods between adjacent pressure spikes that are identical to each other to within a first predetermined threshold error value.

Embodiment 21. The method of embodiments 18-20, further comprising: tracking at least one of a distance that the pipette tip or the pipettor has moved or a position of the pipette tip or the pipettor relative to a reference position.

Embodiment 22. The method of embodiments 18-21, further comprising: aspirating the at least a portion of the liquid from the container when two or more pressure spikes among the series of pressure spikes each has a slope value that is greater than a predetermined threshold slope value, wherein the two or more pressure spikes exhibit the repetition pattern indicative of the pipette tip making contact with the liquid in the container.

Embodiment 23. The method of embodiments 18-22, further comprising: aspirating the at least a portion of the liquid from the container both when the series of pressure spikes exhibits the repetition pattern indicative of the pipette tip making contact with the liquid in the container and when the pipette tip is determined to be located within the container below a known position of a septum seal of the container.

Embodiment 24. The method of embodiment 23, wherein the pipette tip is determined to be located within the container below a known position of a septum seal of the container based on at least one of a distance that the pipette tip or the pipettor has moved or a position of the pipette tip or the pipettor relative to a reference position.

Embodiment 25. The method of embodiments 18-24, further comprising: aspirating the at least a portion of the liquid based at least in part on at least one of previous determinations of liquid level of the liquid in the container, previous determinations of a volume of the liquid in the container, or previous aspirations of the liquid from the container.

Embodiment 26. The method of embodiments 18-25, further comprising: preventing the automated pipettor from aspirating any liquid when a series of pressure spikes exhibits a lack of a regular repetition pattern, indicative of the pipette tip making contact with foam in the container.

Embodiment 27. The method of embodiments 18-26, further comprising: preventing the automated pipettor from aspirating any liquid when each pressure spike in a series of pressure spikes has a slope value that is less than a predetermined threshold slope value, indicative of the pipette tip having passed through a partially sealed septum of the container but not yet contacted liquid.

Embodiment 28. A method, comprising: causing an automated pipettor to lower a pipette tip that is attached to a syringe of the automated pipettor into a container while simultaneously pushing air out of the pipette tip; receiving air pressure measurements from a pressure sensor that monitors air pressure within the syringe, as the automated pipettor is caused to lower the pipette tip into the container; analyzing the received air pressure measurements to determine whether the pipette tip has made contact with a liquid in the container, by identifying, from the air pressure measurements, a series of pressure spikes that exhibits a repetition pattern indicative of the pipette tip making contact with the liquid in the container; and in response to identifying such a series of pressure spikes, causing the automated pipettor to perform one or more tasks.

Embodiment 29. The method of embodiment 28, wherein the repetition pattern indicative of the pipette tip making contact with the liquid in the container comprises at least one of a regular period or a regular frequency among two or more pressure spikes in the series of pressure spikes.

Embodiment 30. The method of embodiment 28 or 29, wherein the repetition pattern comprises at least four consecutive pressure peaks having periods between adjacent pressure peaks that are identical to each other to within a first predetermined threshold error value.

Embodiment 31. The method of embodiments 28-30, wherein the series of pressure spikes comprises two or more pressure spikes each having a slope value that is greater than a predetermined threshold slope value, wherein the two or more pressure spikes exhibit the repetition pattern indicative of the pipette tip making contact with the liquid in the container.

Embodiment 32. The method of embodiments 28-31, further comprising determining a liquid level of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to the leading pressure valley preceding the repetition pattern relative to a known position of the top seal of the container.

Embodiment 33. The method of embodiments 28-32, further comprising determining a volume of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to the leading pressure valley preceding the repetition pattern relative to a known position of the top seal of the container.

Embodiment 34. The method of embodiments 28-33, further comprising: determining a time at which the pipette tip made contact with the liquid in the container, the determined time corresponding to a start of the repetition pattern; wherein causing the automated pipettor to perform one or more tasks comprises causing the automated pipettor to perform one or more tasks based on the determined time at which the pipette tip made contact with the liquid in the container.

Embodiment 35. The method of embodiments 28-34, further comprising: analyzing the received air pressure measurements to determine whether the pipette tip has made contact with foam in the container, by identifying, from the air pressure measurements, a series of pressure spikes that exhibits a lack of a regular repetition pattern, indicative of the pipette tip making contact with foam in the container; and in response to identifying such a series of pressure spikes, preventing the automated pipettor from aspirating any liquid.

Embodiment 36. The method of embodiments 28-35, further comprising: analyzing the received air pressure measurements to determine whether the pipette tip has passed through a partially sealed septum of the container but not yet contacted liquid, by identifying, from the air pressure measurements, a series of pressure spikes, each pressure spike in the series of pressure spikes having a slope value that is less than a predetermined threshold slope value, indicative of the pipette tip having passed through a partially sealed septum of the container but not yet contacted liquid; and in response to identifying such a series of pressure spikes, preventing the automated pipettor from aspirating any liquid.

Embodiment 37. The method of embodiments 28-36, wherein performing the one or more tasks comprises at least one of: based on a determination that the container contains an amount of liquid greater than a predetermined amount of liquid, aspirating the predetermined amount of liquid from the container and transferring the aspirated liquid to a receptacle; based on a determination that the container contains an amount of liquid less than the predetermined amount of liquid, performing one of: aspirating a remaining amount of liquid from the container, moving the pipette tip to a second container containing the same liquid, aspirating an amount of liquid from the second container so that the total amount of liquid in the pipette tip equals the predetermined amount of liquid, and transferring the aspirated liquid to the receptacle; moving the pipette tip to the second container containing the same liquid, aspirating the predetermined amount of liquid from the second container, and transferring the aspirated liquid to the receptacle; or sending or displaying a notification to a user to replace the container with another container having an amount of the same liquid that is greater than the predetermined amount of liquid; based on a determination as to how many more aspirations of liquid can be obtained from the container based on the determined liquid level, sending or displaying a notification to the user indicating a determined number of remaining aspirations of liquid that can be obtained from the container; or based on a determination as to remaining volume of liquid that is in the container based on the determined liquid level, sending or displaying a notification to the user indicating the determined remaining volume of liquid that is in the container.

Embodiment 38. The method of embodiment 37, wherein the receptacle comprises one of a microscope slide or a third container.

Embodiment 39. An apparatus, comprising: at least one processor; and a non-transitory computer readable medium communicatively coupled to the at least one processor, the non-transitory computer readable medium having stored thereon computer software comprising a set of instructions that, when executed by the at least one processor, causes the apparatus to: cause an automated pipettor to lower a pipette tip that is attached to a syringe of the automated pipettor into a container while simultaneously pushing air out of the pipette tip; receive air pressure measurements from a pressure sensor that monitors air pressure within the syringe, as the automated pipettor is caused to lower the pipette tip into the container; analyze the received air pressure measurements to determine whether the pipette tip has made contact with a liquid in the container, by identifying, from the air pressure measurements, a series of pressure spikes that exhibits a repetition pattern indicative of the pipette tip making contact with the liquid in the container; and in response to identifying such a series of pressure spikes, cause the automated pipettor to perform one or more tasks.

Embodiment 40. The apparatus of embodiment 39, wherein the automated pipettor is disposed within a work environment, wherein the apparatus comprises at least one of a processor disposed in the automated pipettor, a computing system communicatively coupled to the automated pipettor and disposed in the work environment, a remote computing system disposed external to the work environment and accessible over a network, or a cloud computing system.

Embodiment 41. A system, comprising: an automated pipettor, comprising: a base; a syringe comprising a syringe body and a plunger; a first motor configured to cause the plunger to move upward or downward relative to the syringe body; a pressure sensor that monitors air pressure within the syringe; and a second motor configured to cause the syringe to move upward or downward relative to the base, wherein a container is disposed in a position that is stationary relative to the base of the automated pipettor; and an apparatus, configured to: cause the automated pipettor to lower a pipette tip that is attached to the syringe of the automated pipettor into the container, by sending first command instructions to the second motor to cause the syringe to move downward relative to the container, while simultaneously causing the plunger of the syringe to continuously and slowly push air out of the pipette tip, by sending second command instructions to the first motor to cause the plunger to move downward relative to the syringe body; receive air pressure measurements from the pressure sensor, as the automated pipettor is caused to lower the pipette tip into the container; analyze the received air pressure measurements to determine whether the pipette tip has made contact with a liquid in the container, by identifying, from the air pressure measurements, a series of pressure spikes that exhibits a repetition pattern indicative of the pipette tip making contact with the liquid in the container; and in response to identifying such a series of pressure spikes, cause the automated pipettor to perform one or more tasks.

Embodiment 42. The system of embodiment 41, wherein the repetition pattern indicative of the pipette tip making contact with the liquid in the container comprises at least one of a regular period or a regular frequency among two or more pressure spikes in the series of pressure spikes.

Embodiment 43. The system of embodiment 41 or 42, wherein the series of pressure spikes comprises two or more pressure spikes each having a slope value that is greater than a predetermined threshold slope value, wherein the two or more pressure spikes exhibit the repetition pattern indicative of the pipette tip making contact with the liquid in the container.

Embodiment 44. The system of embodiments 41-43, wherein the automated pipettor further comprises an X-Y stage that is configured to move the syringe along an X-Y plane that is parallel to a workspace surface on which the base is disposed, wherein the first set of instructions, when executed by the at least one first processor, further causes the apparatus to: cause the automated pipettor to move the pipette tip from a position above the container to a second position along the X-Y plane, by sending third command instructions to the X-Y stage to cause the syringe to move to the second position along the X-Y plane.

Embodiment 45. The system of embodiments 41-44, wherein the automated pipettor is disposed within a work environment, wherein the apparatus comprises at least one of a processor disposed in the automated pipettor, a computing system communicatively coupled to the automated pipettor and disposed in the work environment, a remote computing system disposed external to the work environment and accessible over a network, or a cloud computing system.

Embodiment 46. The system of embodiments 41-45, wherein the apparatus is further configured to: analyze the received air pressure measurements to determine whether the pipette tip has made contact with foam in the container, by identifying, from the air pressure measurements, a series of pressure spikes that exhibits a lack of a regular repetition pattern, indicative of the pipette tip making contact with foam in the container; and in response to identifying such a series of pressure spikes, preventing the automated pipettor from aspirating any liquid.

Embodiment 47. The system of embodiments 41-46, wherein the apparatus is further configured to: analyze the received air pressure measurements to determine whether the pipette tip has passed through a partially sealed septum of the container but not yet contacted liquid, by identifying, from the air pressure measurements, a series of pressure spikes, each pressure spike in the series of pressure spikes having a slope value that is less than a predetermined threshold slope value, indicative of the pipette tip having passed through a partially sealed septum of the container but not yet contacted liquid; and in response to identifying such a series of pressure spikes, preventing the automated pipettor from aspirating any liquid.

Embodiment 48. The system of embodiments 41-47, wherein performing the one or more tasks comprises at least one of: based on a determination that the container contains an amount of liquid greater than a predetermined amount of liquid, aspirating the predetermined amount of liquid from the container and transferring the aspirated liquid to a receptacle; based on a determination that the container contains an amount of liquid less than the predetermined amount of liquid, performing one of: aspirating a remaining amount of liquid from the container, moving the pipette tip to a second container containing the same liquid, aspirating an amount of liquid from the second container so that the total amount of liquid in the pipette tip equals the predetermined amount of liquid, and transferring the aspirated liquid to the receptacle; moving the pipette tip to the second container containing the same liquid, aspirating the predetermined amount of liquid from the second container, and transferring the aspirated liquid to the receptacle; or sending or displaying a notification to a user to replace the container with another container having an amount of the same liquid that is greater than the predetermined amount of liquid; based on a determination as to how many more aspirations of liquid can be obtained from the container based on the determined liquid level, sending or displaying a notification to the user indicating a determined number of remaining aspirations of liquid that can be obtained from the container; or based on a determination as to remaining volume of liquid that is in the container based on the determined liquid level, sending or displaying a notification to the user indicating the determined remaining volume of liquid that is in the container.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. An apparatus, comprising:
an automated pipettor having a pipette tip affixed thereto; and
a pressure sensor in fluid communication with the pipette tip;
wherein the apparatus is configured to aspirate at least a portion of the liquid from a container having a liquid contained therein when a series of pressure spikes exhibits a repetition pattern indicative of the pipette tip making contact with the liquid in the container.

2. The apparatus of claim 1, wherein the repetition pattern indicative of the pipette tip making contact with the liquid in the container comprises at least one of a regular period or a regular frequency among two or more pressure spikes in the series of pressure spikes.

3. The apparatus of claim 1, wherein the apparatus is further configured to track at least one of a distance that the pipette tip or the pipettor has moved or a position of the pipette tip or the pipettor relative to a reference position.

4. The apparatus of claim 1, wherein the apparatus is further configured to aspirate the at least a portion of the liquid from the container when two or more pressure spikes among the series of pressure spikes each has a slope value that is greater than a predetermined threshold slope value, wherein the two or more pressure spikes exhibit the repetition pattern indicative of the pipette tip making contact with the liquid in the container.

5. The apparatus of claim 1, wherein the apparatus is further configured to aspirate the at least a portion of the liquid from the container both when the series of pressure spikes exhibits the repetition pattern indicative of the pipette tip making contact with the liquid in the container and when the pipette tip is determined to be located within the container below a known position of a septum seal of the container.

6. The apparatus of claim 5, wherein the pipette tip is determined to be located within the container below a known position of a septum seal of the container based on at least one of a distance that the pipette tip or the pipettor has moved or a position of the pipette tip or the pipettor relative to a reference position.

7. The apparatus of claim 1, wherein the apparatus is further configured to aspirate the at least a portion of the liquid based at least in part on at least one of previous determinations of liquid level of the liquid in the container, previous determinations of a volume of the liquid in the container, or previous aspirations of the liquid from the container.

8. The apparatus of claim 1, wherein the automated pipettor is configured, using a first type of actuation, to push air through the pipette tip and configured, using a second type of actuation different from the first type of actuation, to move a syringe and the pipette tip that is affixed to the syringe downward toward the container, wherein the apparatus is further configured to distinguish pressure spikes corresponding to the first type of actuation from pressure spikes corresponding to the second type of actuation and to aspirate the liquid from the container when a series of pressure spikes caused by the first type of actuation exhibits the repetition pattern indicative of the pipette tip making contact with the liquid in the container.

9. The apparatus of claim 8, wherein the automated pipettor further comprises a plunger motor and a Z-axis motor, wherein the plunger motor causes the first type of actuation, while the Z-axis motor causes the second type of actuation, wherein the first type of actuation and the second type of actuation are distinguishable from each other based on one of the following:
the plunger motor comprises a servo motor, while the Z-axis motor comprises a stepper motor;
the plunger motor comprises a stepper motor, while the Z-axis motor comprises a servo motor;
the plunger motor and the Z-axis motor are both stepper motors, wherein a first pressure curve resultant from at least one of characteristics of the pipette tip or characteristics of the Z-axis motor that influence how the pipette tip moves is different from a second pressure curve resultant from at least one of characteristics of the plunger or characteristics of the plunger motor that influence how the plunger moves; or
the plunger motor and the Z-axis motor are both servo motors, wherein a third pressure curve resultant from at least one of characteristics of the pipette tip or characteristics of the Z-axis motor that influence how the pipette tip moves is different from a fourth pressure curve resultant from at least one of characteristics of the plunger or characteristics of the plunger motor that influence how the plunger moves;
wherein the characteristics of the pipette tip comprise an outer diameter of the pipette tip, wherein the characteristics of the Z-axis motor comprise at least one of type of motor, control of motor, or transmission between the motor and the pipette tip, wherein the characteristics of the plunger comprise a diameter of the plunger, and wherein the characteristics of the plunger motor comprise at least one of type of motor, control of motor, or transmission between the motor and the plunger.

10. The apparatus of claim 1, wherein the repetition pattern comprises at least four pressure spikes having periods between adjacent pressure spikes that are identical to each other to within a first predetermined threshold error value.

11. The apparatus of claim 1, wherein the apparatus is further configured to:
determine a liquid level of the liquid in the container based on the determined repetition pattern exhibited by the pressure spikes as the pipette tip is moved within the container and based on an indication that the pipette tip has made contact with the liquid in the container.

12. The apparatus of claim 11, wherein determining the liquid level of the liquid in the container comprises determining a liquid level of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to a leading pressure valley preceding the repetition pattern relative to a known position of the top seal of the container.

13. The apparatus of claim 11, wherein determining the liquid level of the liquid in the container comprises determining a volume of the liquid in the container based at least in part on one or more of geometry of the container, height of the container, a distance between a reference point on the container and a reference point on the automated pipettor, height of the pipette tip relative to the reference point on the container, position of the pipette tip after the pipette tip has passed through a top seal of the container, position of the pipette tip corresponding to a start of the repetition pattern, or position of the pipette tip corresponding to a leading pressure valley preceding the repetition pattern relative to a known position of the top seal of the container.

14. The apparatus of claim 11, wherein determining the liquid level of the liquid in the container comprises determining a time at which the pipette tip made contact with the surface of the liquid in the container, the determined time corresponding to a start of the repetition pattern.

15. The apparatus of claim 1, wherein the apparatus comprises at least one of a processor disposed in the automated pipettor, a computing system communicatively coupled to the automated pipettor and disposed in the work environment, a remote computing system disposed external to the work environment and accessible over a network, or a cloud computing system.

16. The apparatus of claim 1, wherein the apparatus is further configured to prevent the automated pipettor from aspirating any liquid when a series of pressure spikes exhibits a lack of a regular repetition pattern, indicative of the pipette tip making contact with foam in the container.

17. The apparatus of claim 1, wherein the apparatus is further configured to prevent the automated pipettor from aspirating any liquid when each pressure spike in a series of pressure spikes has a slope value that is less than a predetermined threshold slope value, indicative of the pipette tip having passed through a partially sealed septum of the container but not yet contacted liquid.

18. A method, comprising:
lowering an automated pipettor having a pipette tip in liquid communication therewith into a container while dispensing air from the pipette tip and measuring air pressure within the pipette tip; and
aspirating, using the automated pipettor, at least a portion of a liquid in the container when a series of pressure spikes exhibits a repetition pattern indicative of the pipette tip making contact with liquid in the container.

19. The method of claim 18, wherein the repetition pattern indicative of the pipette tip making contact with the liquid in the container comprises at least one of a regular period or a regular frequency among two or more pressure spikes in the series of pressure spikes.

20. The method of claim 18, wherein the repetition pattern comprises at least four pressure spikes having periods between adjacent pressure spikes that are identical to each other to within a first predetermined threshold error value.

21.-27. (canceled)
